(19) United States
(12) Patent Application Publication
(10) Pub. No.: US 2002/0039352 A1
(43) Pub. Date: Apr. 4, 2002

(54) Methods, systems, and computer program products for managing a service provided by a network

(76) Inventors: Ramzi El-Fekih, Ft. Lauderdale, FL (US); Guoqiang Liu, Plantation, FL (US)

Correspondence Address: MYERS BIGEL SIBLEY & SAJOVEC, PO BOX 37428, RALEIGH, NC, 27627, US

(21) Appl. No.: 09/932,739

(22) Filed: Aug. 17, 2001

Related U.S. Application Data
(60) Provisional application No. 60/225,892, filed on Aug. 17, 2000.

(51) Int. Cl. H04J 1/16

(52) U.S. Cl. 370/252

(57) ABSTRACT

Embodiments of methods, systems, and computer program products are provided for managing a service. For example, service quality and/or performance requirements may be obtained from a client and quality and/or performance data may be collected from the network. The collected quality and/or performance data may then be compared with the service quality and/or performance requirements to determine if the network quality and/or performance requirements are satisfied. Thus, a service may be comprehensively managed by using collected quality and/or performance data from the network to verify that the network is providing a level of service expected by a client.

### RELATED APPLICATION

This application claims the benefit of U.S. Provisional Application No. 60/225,892, filed Aug. 17, 2000, the disclosure of which is hereby incorporated herein by reference.

### BACKGROUND OF THE INVENTION

The present invention relates generally to the field of communication networks, and, more particularly, to managing a network service.

Deregulation of telecommunications providers, new communications technologies, and the Internet have often been cited as important factors in bringing about increased competition in the delivery of telecommunications services. As a result of this increased competition, telecommunications providers have generally been under pressure to improve efficiency and cut costs and yet still maintain a high quality level of service for their customers. In this competitive environment, one area in which telecommunications providers may be able to gain a competitive edge is in the support systems that are used to operate, manage, and maintain the telecommunications networks. These support systems may be called operational support systems (OSS).

Broadly stated, an OSS for a telecommunications network may include software services that are used to support the operations of a telecommunications network. Three support areas that may be addressed by a telecommunications OSS are 1) provisioning and order management, 2) billing and customer support, and 3) service quality management. Provisioning and order management may include such functions as service activation, service order processing, and service provisioning. Billing and customer support may include such functions as data collection, retail and wholesale billing, bill compilation, and customer care. Finally, service quality management may include such functions as service level agreements (SLAs), quality of service delivery, fault management, performance monitoring, error analysis, and security.

In general, OSS software solutions have been developed to address a specific task domain, such as one of the three support areas cited above at the network and/or service level. There exists a need, however, for improved service management systems and methods that may be used by service providers and/or their customers.

### SUMMARY OF THE INVENTION

Embodiments of the present invention may include methods, systems, and computer program products for managing a service provided by a network. For example, service quality and/or performance requirements may be obtained from a client and quality and/or performance data may be collected from the network. The collected quality and/or performance data may then be compared with the service quality and/or performance requirements to determine if the service quality and/or performance requirements are satisfied. Thus, a service may be comprehensively managed by using collected quality and/or performance data from the network to verify that the network is providing a service quality level expected by a client.

In particular embodiments of the present invention, the quality and/or performance data may be collected by querying one or more access network elements that are configured at the edge of the network and/or by querying a data collection agency that is in communication with one or more access network elements. Once the quality and/or performance data is collected, the data may be stored in a repository for analysis. Accordingly, the quality and/or performance data may be retrieved from the repository to be analyzed and then the performance analysis results may be stored in the repository.

In further embodiments of the present invention, the network may be embodied as an asynchronous transfer mode (ATM) network that includes a virtual private network (VPN). The VPN may include one or more virtual channels (VCs). Moreover, each access network element may include one or more network interfaces (NIs).

In still further embodiments of the present invention, the quality and/or performance data may be analyzed to determine or compute quality and/or performance measures corresponding to various quality and/or performance parameters for the VPN, the VCs and/or the NIs. In particular embodiments of the present invention, these quality and/or performance measures may include, but are not limited to, an availability measure, a mean time to restore (MTTR) measure, a mean time between service outages (MTBSO) measure, a bandwidth utilization measure, a delay measure, an error measure, and a fault measure.

In yet further embodiments of the present invention, thresholds may be defined for quality and/or performance parameters, which may be viewed as establishing an expected or required level of service. A client, for example, may send a report request for any of the various quality and/or performance parameters. In response, a report may be sent to the client containing the quality and/or performance measure that has been determined or computed for a quality and/or performance parameter along with a comparison of the quality and/or performance measure with any threshold that may have been defined. This may allow the client to readily determine whether the network is providing a level of service that meets the client's expectations or standards. This may also alert a service provider to repair or reconfigure network resources.

In still further embodiments of the present invention, a quantitative quality and/or performance appraisal or “health index” may be computed for the VPN, the VCs, and/or the NIs. For example, a set of quality and/or performance parameters may be defined that will be used to evaluate the quality and/or performance of the network. For each quality and/or performance parameter, configurable criteria may be assigned that provides a standard level of service for that particular quality and/or performance parameter. Performance measures for the set of quality and/or performance parameters may then be determined or computed as discussed in the foregoing, which may then be compared with the configurable criteria. A grade may be assigned for each quality and/or performance parameter based on the difference between the quality and/or performance measure and the configurable criteria for that parameter. The grades for each of the quality and/or performance parameters may then be summed to obtain an overall quantitative quality and/or performance appraisal or health index.

In further embodiments of the present invention, threshold ranges may be assigned for each configured value. The threshold ranges may be used in assigning the grades for the quality and/or performance parameters by determining the deviation between the quality and/or performance measure and the configured value for each quality and/or performance parameter and then comparing this deviation to the threshold range associated with the configured value.

In still further embodiments of the present invention, the quality and/or performance parameters that comprise the quantitative quality and/or performance appraisal or health index may be weighted differently. Accordingly, a weight coefficient may be associated with each of the quality and/or performance parameters, which is then used to multiply the grade for the parameter before the grades are summed.

In other embodiments of the present invention, a service agreement may be established, maintained, and monitored between, for example, a service provider and a customer. Specifically, one or more service templates may be generated for a service provider's offering that each includes one or more conformance categories having threshold ranges associated therewith. The service provider and/or the customer may then select a service template on which to base a contract, such as a service level agreement (SLA). In particular, a threshold may be associated with each of the conformance categories that is within the specified threshold range. The selected service template along with the thresholds that are associated with each of the conformance categories may then be associated with a VPN to generate the service agreement.

In particular embodiments of the present invention, the service agreement may be monitored to ensure that the service provider is complying with the agreement by collecting quality and/or performance data from the network that are associated with the conformance categories, processing the collected quality and/or performance data, and then comparing the processed quality and/or performance data with the conformance category thresholds to determine whether the service provider is in compliance.

In further embodiments of the present invention, the conformance categories may include customer traffic parameters. Accordingly, quality and/or performance data may be collected from the network that are associated with the customer traffic parameters. This quality and/or performance data may then be processed and compared with the thresholds defined for the customer traffic parameters to determine whether the customer is in compliance with the service agreement.

In still further embodiments of the present invention, a service provider and/or customer may request a service agreement conformance report. In response, a report may be sent to the service provider and/or customer that compares the processed quality and/or performance data with the thresholds for each of the conformance categories.

In still other embodiments of the present invention, the traffic carried by a network may be shaped upon the request of a client and with the client's advice, to prioritize the transmission of traffic entering the network, to increase network throughput and performance, and to improve the quality of service provided by the network. In this regard, multiple traffic types may be provided and a business priority and a traffic priority may be associated with each traffic type. In addition, quality and/or performance data may be collected from the network that may be indicative of availability and bandwidth utilization along with access network element buffer capacities, throughput, error rate, etc. Accordingly, when a proposed traffic description is received from a client, the traffic description may be correlated with one or more of the traffic types. The network may then be configured based on the correlation of the traffic description with the traffic types, business and traffic priorities, and the collected quality and/or performance data.

In still further embodiments of the present invention, a service provider and/or customer may request a traffic report for an access network element. In response, a report may be sent to the service provider and/or customer that provides an indication of the traffic carried by that access network element.

Thus, in accordance with the present invention, a service management system may be used to retrieve quality of service information from a network, analyze that information, and compare the analyzed information against defined service or conformance thresholds to determine whether a service and/or the network is performing up to expectations. If the service and/or network is deficient in some way, then a client, such as a service provider or customer, may be notified to allow the client to take corrective action by, for example, reshaping the traffic on the network.

While the present invention has been described above primarily with respect to method aspects of the invention, it will be understood that the present invention may be embodied as methods, systems, and/or computer program products.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates service management system architectures in accordance with embodiments of the present invention;

FIG. 2 is a block diagram that illustrates data processing systems in accordance with embodiments of the present invention;

FIGS. 3-5 are service management system software architecture block diagrams that illustrate methods, systems, and computer program products for managing the quality of service provided by a network in accordance with embodiments of the present invention;

FIG. 6 is a client computer system software architecture block diagram that illustrates methods, systems, and computer program products for managing the quality of service provided by a network in accordance with embodiments of the present invention; and

FIGS. 7-20 are flow charts that illustrate exemplary operations of methods, systems, and computer program products for managing the quality of service provided by a network in accordance with embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

For purposes of illustration and in no way limited thereto, the present invention is described herein in the context of managing services provided by an asynchronous transfer mode (ATM) network. It will be understood, however, that the concepts and principles of the present invention may be applied to managing services provided by alternative types of telecommunications networks, such as frame relay networks, internet protocol (IP) networks, digital subscriber line (DSL) networks, etc.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

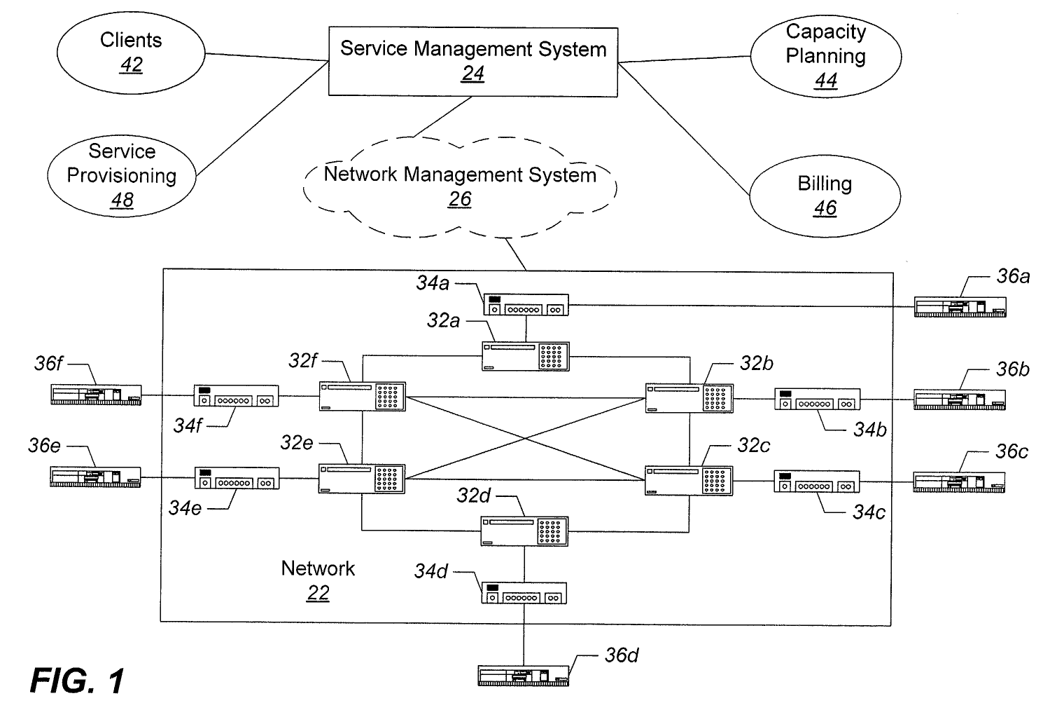

Referring now to FIG. 1, an exemplary service management system architecture, in accordance with embodiments of the present invention, includes a network 22, such as an ATM network, a service management system 24, and, optionally, a network management system 26 that may be used to interface the service management system 24 to the network 22. It will be understood that the network 22 may be embodied as various network types in accordance with embodiments of the present invention. For purposes of illustration, the network 22 is described herein in the context of an ATM network. The network 22 may include one or more core network elements 32a, 32b, 32c, 32d, 32e, and 32f and one or more access network elements 34a, 34b, 34c, 34d, 34e, and 34f as shown. The access network elements 34a, 34b, 34c, 34d, 34e, and 34f comprise those network elements that are configured at the edge of the network 22 and provide access to the network 22 for access devices from another public or private network. Accordingly, the access network elements 34a, 34b, 34c, 34d, 34e, and 34f may include one or more ports through which a user network interface (UNI) or network interface (M) may be defined. As illustrated in FIG. 1, each access network element 34a, 34b, 34c, 34d, 34e, and 34f is in communication with a one or more customer access devices 36a, 36b, 36c, 36d, 36e, and 36f over one or more NIs.

The service management system 24 may communicate with the access network elements 34a, 34b, 34c, 34d, 34e, and 34f and/or the core network elements 32a, 32b, 32c, 32d, 32e, and 32f to collect, for example, performance, configuration, topology, timing, and/or traffic data therefrom. The data collected by the service management system 24 are stored in repositories for use by other applications. The repositories may be implemented as relational database management systems (RDBMS) that support the structured query language (SQL). It may be desirable to store the collected data in a SQL database to facilitate access of the collected data by other applications. Advantageously, applications may access a SQL database without having to know the proprietary interface of the underlying RDBMS.

Client applications 42 may communicate with the service management system 24 to access reports generated by the service management system 24 based on analyses of the collected data and to manage the services provided by the network 22 (e.g., determine whether the services provided by the network 22 are in conformance with an agreed upon quality of service). Capacity planning applications 44 may communicate with the service management system 24 to assist an administrator in shaping/configuring the topology/shape of the network 22 and/or to distribute traffic carried by the network 22. Billing applications 46 may communicate with the service management system 24 to generate bills based on analyses of the data collected from the network 22. Finally, service provisioning applications 48 may communicate with the service management system 24 to facilitate the introduction of new services into the network 22.

The service management system 24 and/or data processing system(s) supporting the client applications 42, the capacity planning applications 44, the billing applications 46, and the service provisioning applications 48 may be configured with computational, storage, and control program resources for managing service quality, in accordance with the present invention. Thus, the service management system 24 and the data processing system(s) supporting the client applications 42, the capacity planning applications 44, the billing applications 46, and the service provisioning applications 48 may each be implemented as a single processor system, a multi-processor system, or even a network of stand-alone computer systems.

Although FIG. 1 illustrates an exemplary service management system architecture, it will be understood that the present invention is not limited to such a configuration but is intended to encompass any configuration capable of carrying out the operations described herein.

To provide context for the description of embodiments of the present invention set forth hereafter, it may be helpful to review some basic concepts and terminology used in ATM networking. ATM is a networking technology based on transferring data in fixed length (53 bytes) cells or packets. The relatively constant size of ATM cells may allow ATM equipment to transmit video, audio, and computer data over the same network while handling sometimes divergent requirements with regard to bandwidth, error control, etc. ATM supports two types of connections: a virtual path connection (VPC) and a virtual channel connection (VCC). A virtual channel (VC) is a unidirectional communication capability for the transport of ATM cells. Virtual channel links are concatenated to form a VCC. A virtual path (VP) is a bundle of VC links in which all of the VC links have the same endpoints. VP links are concatenated to form a VPC. ATM uses a VP and VC switching hierarchy.

When purchasing ATM service, a customer may be provided with a choice of the following ATM service classes: 1) constant bit rate (CBR), 2) real time variable bit rate (RT-VBR), 3) non-real time variable bit rate (NRT-VBR), 4) unspecified bit rate (UBR), and 5) available bit rate (ABR). CBR specifies a fixed bit rate so that data is sent in a steady stream. CBR is often used for delay sensitive applications, such as video and voice. VBR specifies a throughput capacity, but data is not sent evenly. RT-VBR is often used for applications that require strict timing control, such as packetized voice or video. NRT-VBR is often used for applications that can tolerate variable but predictable transit delays. UBR does not specify any throughput level; therefore, the ATM network uses its “best effort” to meet the transmitter's bandwidth requirements. UBR is often used for file transfer applications, which are generally delay tolerant. ABR specifies a guaranteed minimum throughput capacity, but otherwise the ATM network uses its “best effort” to meet the transmitter's bandwidth requirements. ABR, like UBR, is often used for applications that are delay tolerant.

An ATM service provider may logically partition an ATM network into one or more virtual private networks (VPNs) in which a public ATM network appears to a customer as a private network (e.g., unique customer addressing features, customer specific network management features, etc.). A VPN may comprise one or more VCs. It will be understood, however, that the network 22, in general, may be partitioned into one or more VPNs. A VPN is a set of nodes on a public network that communicate among themselves using encryption technology so that their messages are safe from being intercepted and understood by unauthorized users as if the nodes were connected by private lines.

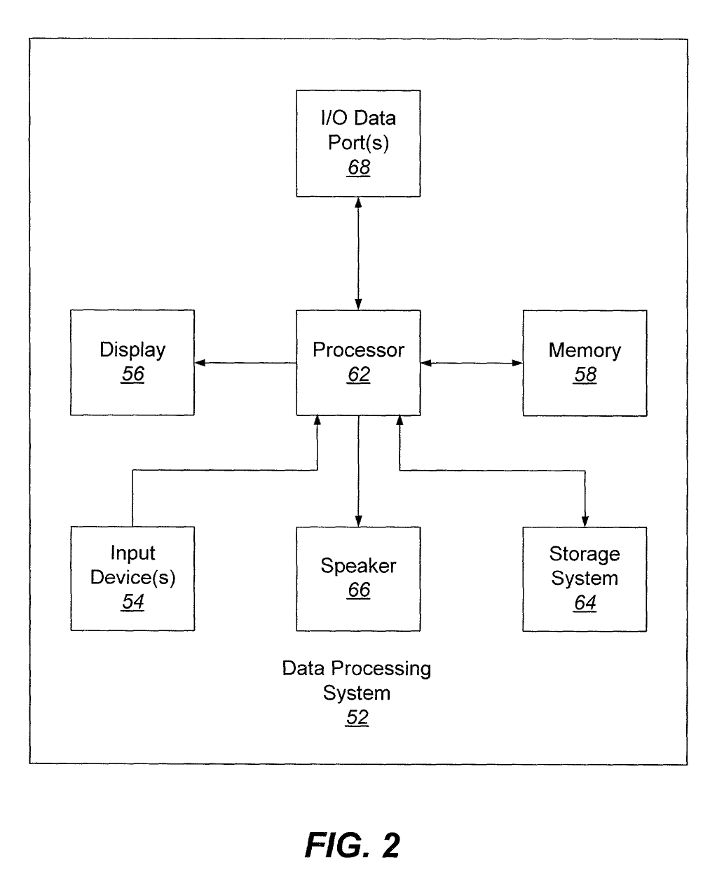

With reference to FIG. 2, the service management system 24 may be embodied as a data processing system 52. Embodiments of the data processing system 52 may include input device(s) 54, such as a keyboard or keypad, a display 56, and a memory 58 that communicate with a processor 62. The data processing system 52 may further include a storage system 64, a speaker 66, and an input/output (I/O) data port(s) 68 that also communicate with the processor 62. The storage system 64 may include removable and/or fixed media, such as floppy disks, ZIP drives, hard disks, or the like, as well as virtual storage, such as a RAMDISK. The I/O data port(s) 68 may be used to transfer information between the data processing system 52 and another computer system or a network (e.g., the Iternet). These components may be conventional components such as those used in many conventional computing devices, which may be configured to operate as described herein.

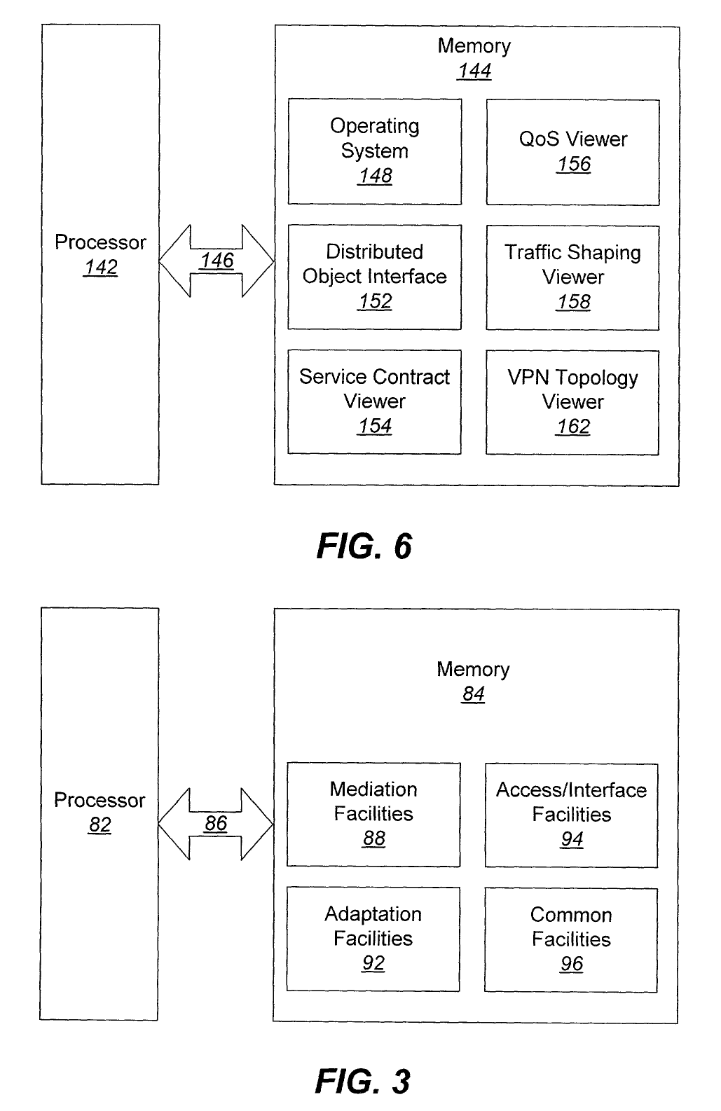

FIG. 3 illustrates a processor 82 and a memory 84 that may be used in embodiments of the service management system 24 in accordance with the present invention. The processor 82 communicates with the memory 84 via an address/data bus 86. The processor 82 may be, for example, a commercially available or custom microprocessor. The memory 84 is representative of the overall hierarchy of memory devices containing the software and data used to manage the quality of service provided by a network in accordance with the present invention. The memory 84 may include, but is not limited to, the following types of devices: cache, ROM, PROM, EPROM, EEPROM, flash, SRAM, and DRAM.

As shown in FIG. 3, the memory 84 may hold four major categories of software and data: a mediation facilities program module 88, an adaptation facilities program module 92, an access/interface facilities program module 94, and a common facilities program module 96. The mediation facilities module 88 may be configured to collect data and other service and network information from the network 22 directly through the access network elements 34a, 34b, 34c, 34d, 34e, and 34f and/or indirectly through a data collection agency. The mediation facilities module 88 may be further configured to store and analyze the collected data, to interact with the client applications 42, to convey information to the client applications 42, and to receive input from the client applications 42.

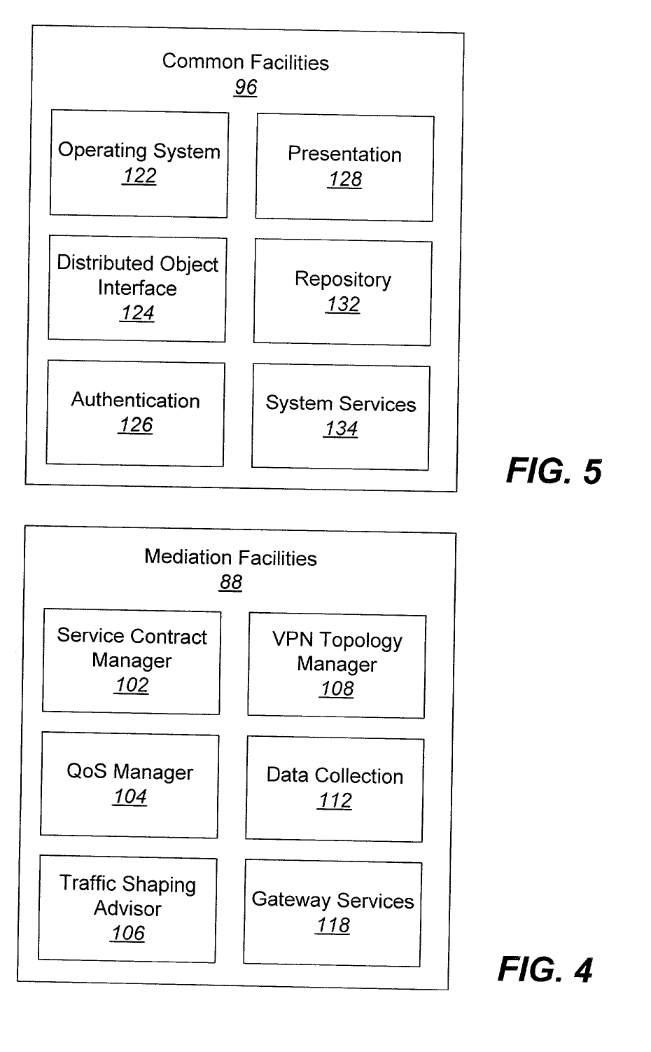

The mediation facilities module 88, in accordance with exemplary embodiments of the present invention, is shown in more detail in FIG. 4. In particular, the mediation facilities module 88 may comprise a service contract manager module 102, a Quality of Service (QoS) manager module 104, a traffic shaping advisor module 106, a VPN topology manager module 108, a data collection module 112, and a gateway services module 118. Exemplary functions of these respective modules will be discussed hereafter.

The service contract manager module 102 may be configured to create, remove, and maintain information that is associated with a Service Level Agreement (SLA) between, for example, a service provider and a customer of the service provider. The service contract manager module 102 may also contain validation rules, crediting rules, and/or business rules to assure the integrity of SLA information that is contained in a local repository.

The service contract manager module 102 may be configured to use service quality information obtained from Web sites, other systems, and/or from a local repository to determine whether the service provided by a service provider or the traffic generated by a customer is in conformance with a SLA generated and maintained by the service contract manager module 102.

The QoS manager module 104 may be configured to specify, remove, and maintain all QoS expected results. Typically, QoS thresholds relate to parameters that are associated with service classes, such as CBR, RT-VBR, NRT-VBR, UBR, and ABR for ATM, and business operation expectations. The QoS manager module 104 may also contain validation rules to assure the integrity of QoS information that is contained in a repository.

The traffic shaping advisor module 106 may be configured to allow a client, e.g., a service provider, to specify or establish the traffic shaping characteristics for VCs supported by the access network elements 34a, 34b, 34c, 34d, 34e, and 34f Based on the users traffic characteristics, available bandwidth, and business priorities, the traffic shaping advisor module 106 may generate a proposed configuration for the affected access network elements 34a, 34b, 34c, 34d, 34e, and 34f and may update the access network elements 34a, 34b, 34c, 34d, 34e, and 34f upon approval of the client.

The VPN topology manager module 108 may be configured to specify, remove, and maintain the service topology information associated with a service provider's VPN. The topology information retained in a repository may include information that is relevant to the delivery of end-to-end connection-oriented services. For example, the VPN topology manager module 108 may collect and maintain status information for each service segment in the network 22. The VPN topology manager module 108 may be further configured to retrieve collected quality and/or performance data and topology information from a repository and to analyze the collected quality and/or performance data and topology information through application of one or more algorithmic techniques. The analyzed quality and/or performance data and topology information may then be stored in a repository.

The data collection module 112 may be configured to periodically query the access network elements 34a, 34b, 34c, 34d, 34e, and 34f for network quality and/or performance data, service data, and topology information, and to store the collected data and information into a repository. The frequency with which the queries are performed may be a configurable parameter with an exemplary default value of 15 minutes.

Lastly, the gateway services module 118 may be configured to support interactions between mediation facilities module 88 software and third-party applications and systems, such as billing system software or trouble ticket software. For example, when a third-party application requests information from the mediation facilities module 88, the gateway services module 118 may process the request and invoke the appropriate software module to fulfill the request. The gateway services module 118 may also process requests from the mediation facilities module 88 for information from third-party applications and systems.

Returning to FIG. 3, the adaptation facilities module 92 may be configured to facilitate interaction between the mediation facilities module 88 and the access network elements 34a, 34b, 34c, 34d, 34e, and 34f. More specifically, the adaptation facilities module 92 may hide the specific hardware implementation or software protocols associated with specific access network elements 34a, 34b, 34c, 34d, 34e, and 34f from the mediation facilities module 88. This may allow the mediation facilities module 88 software to be written at a high level without introducing dependencies for specific hardware or software protocols used by the underlying access network elements 34a, 34b, 34c, 34d, 34e, and 34f. As new access network elements 34a, 34b, 34c, 34d, 34e, and 34f are introduced into the network 22, the adaptation facilities module 92 may be updated with new object-oriented classes to facilitate interaction between the mediation facilities module 88 and the new access network elements 34a, 34b, 34c, 34d, 34e, and 34f.

The access/interface facilities module 94 may be configured to cooperate with the adaptation facilities module 92 to control communication between the adaptation facilities module 92 and the access network elements 34a, 34b, 34c, 34d, 34e, and 34f. Thus, the access/interface facilities module 94 may include the communication protocols used to transfer information between the adaptation facilities module 92 and the access network elements 34a, 34b, 34c, 34d, 34e, and 34f. These communication protocols may include, but are not limited to, the simple network management protocol (SNMP), the file transfer protocol (FTP), the extensible markup language (XML) protocol, and proprietary application programming interface (API) protocols.

The common facilities module 96 may include those service management system 24 software resources and utilities that may provide a software infrastructure for the mediation facilities module 88, the adaptation facilities module 92, and the access/interface facilities module 94. The common facilities module 96, in accordance with exemplary embodiments of the present invention, is shown in more detail in FIG. 5. The common facilities module 96 may comprise an operating system module 122, a distributed object interface module 124, an authentication module 126, a presentation module 128, a repository module 132, and a system services module 134. Exemplary functions of these respective modules will be discussed hereafter.

The operating system 122 controls the operation of the service management system 24. In particular, the operating system 122 may manage the service management system's resources and may coordinate execution of programs by the processor 82. The distributed object interface module 124 may be configured to allow the software modules in the memory 84 to be implemented as an object-oriented system and may facilitate communication between the various software objects. In addition, the distributed object interface module 124 may also allow the objects to be distributed across a heterogeneous network. For example, the objects may be distributed across different data processing systems in a network and yet appear to each other as if they were local. In a distributed object-oriented computer system, client objects may be given object handles to reference remote server objects. A remote object is an object whose class is implemented in a process that is different from the process in which the object handle resides. Moreover, a remote object may be implemented on a data processing system that is remote from the data processing system on which the object handle resides. An object handle identifies a remote, server object and may allow a client object to invoke member functions of the remote object. Three exemplary distributed object models are the Distributed Component Object Model (DCOM), the Common Object Request Broker Architecture (CORBA) model, and the Java Remote Method Invocation (RMI) model. These three models are briefly discussed hereafter.

The DCOM model uses a protocol called Object Remote Procedure Call (ORPC) to support remote objects. A DCOM server object can support multiple interfaces with each interface representing a different behavior of the object. In general, an interface is a set of functionally related methods. A DCOM client object may acquire a pointer to one of a DCOM server object's interfaces and may invoke methods through that pointer as if the server object resided in the DCOM client object's address space. Resources for developing distributed software using DCOM may be obtained from Microsoft Corporation, One Microsoft Way, Redmond, Wash. 98052.

The CORBA model is based on an Object Request Broker (ORB) that acts as an object bus over which objects may transparently interact with one another irrespective of whether they are located locally or remotely. A CORBA server object supports an interface that consists of a set of methods. A particular instance of a CORBA server object is identified by an object reference. The object reference may be used by a CORBA client object to make method calls to the CORBA server object as if the CORBA client object and the CORBA server object shared the same address space. Resources for developing distributed software using CORBA may be obtained from the Object Management Group, 250 First Avenue, Needham, Mass. 02494.

The Java RMI model is specific to the Java programming language and relies on a protocol called Java Remote Method Protocol (JRMP). A Java RMI server object supports an interface that can be used by a Java RMI client object running on a different Java Virtual Machine (JVM) than the Java RMI server object to access Java RMI server object methods. In particular, a naming mechanism called RMIRegistry is implemented that contains information about the Java RMI server objects and runs on the server JVM. A Java RMI client may acquire a reference to a Java RMI server object by doing a lookup in the RMIRegistry. The Java RMI server object reference may then be used by the Java RMI client object to invoke Java RMI server object methods as if the Java RMI client and server objects resided on the same JVM. Resources for developing distributed software using Java RMI may be obtained from Sun Microsystems, Inc., 901 San Antonio Road, Palo Alto, Calif. 94303.

Returning to FIG. 5, the authentication module 126 may be configured to identify a particular client via, for example, a client identification, to determine what rights or access privileges that client may have with regard to applications provided by the service management system 24, SLA reports, and/or traffic shaping capabilities. In general, the authentication module 126 may be configured to provide security services for the service management system 24.

The presentation module 128 may be configured to provide an interface for communication between the client applications 42 and the service management system 24. For example, the presentation module 128 may provide graphical user interfaces (GUIs) that may be used by a client, such as a service provider or customer to access network quality and/or performance reports, generate an SLA, and/or shape traffic on the network 22.

The repository module 132 may be configured to manage interactions with an RDBMS. In exemplary embodiments of the present invention, service management system 24 software modules may register with the repository module 132 to be notified when events occur and when changes are made to the network 22 and have been reflected in the RDBMS. For example, when the repository service is used to change or update information regarding a particular network element of the network 22, a service, or a quality parameter, the repository module 132 may notify all subscribing software modules of the new information.

Finally, the system services module 134 may be configured to provide miscellaneous utilities, such as a logging facility of messages generated by the service management system 24 software modules, an exception handler to determine if any of the logged messages merit action by the service management system 24, such as error recovery and/or error notification, and a system integrity monitor to monitor the status of both hardware and software modules in the service management system 24 to check for failures, inactivity, etc.

FIG. 6 illustrates a processor 142 and a memory 144 that may be used in embodiments of the client applications 42 in accordance with the present invention. The processor 142 communicates with the memory 144 via an address/data bus 146. The processor 142 may be, for example, a commercially available or custom microprocessor. The memory 144 is representative of the overall hierarchy of memory devices containing the software and data used to cooperate with the service management system 24 to manage the quality of service provided by a network in accordance with the present invention. The memory 144 may include, but is not limited to, the following types of devices: cache, ROM, PROM, EPROM, EEPROM, flash, SRAM, and DRAM.

As shown in FIG. 6, the memory 144 may hold six major categories of software and data: an operating system 148, a distributed object interface program module 152, a service contract viewer program module 154, a QoS viewer program module 156, a traffic shaping viewer program module 158, and a VPN topology viewer program module 162.

The operating system 148 controls the operation of the client applications 42. In particular, the operating system 148 may manage the client computer system's resources and may coordinate execution of programs by the processor 142. The distributed object interface module 152 maybe configured to allow the software modules in the memory 144 to be implemented as an object-oriented system and may facilitate communication between the various software objects. In addition, the distributed object interface module 152 may also allow the objects to be distributed across a heterogeneous network. Exemplary models for implementing the distributed object interface module 152 may include the DCOM, CORBA, and Java RMI models discussed hereinabove.

The service contract viewer module 154, QoS viewer module 156, traffic shaping viewer module 158, and VPN topology viewer module 162 on a client computer system respectively cooperate with the service contract manager module 102, the QoS manager module 104, the traffic shaping advisor module 106, and the VPN topology manager module 108 on the service management system 24 to exchange information between the client computer system and the service management system 24.

The service contract viewer module 154 may be configured to cooperate with the service contract manager module 102 to generate an SLA and to request and receive conformance reports that indicate whether the SLA is being adhered to. The SLA may include multiple conformance categories that may be based on, for example, availability, delay, errors, restore time, and/or time between outages. The conformance categories may also include customer traffic parameters, such as peak cell rate (PCR), sustainable cell rate (SCR), cell delay variation tolerance (CDVT), ATM generalized cell rate algorithm (GCRA), and usage parameter control (UPC) disagreement for an ATM network.

The QoS viewer module 156 may be configured to cooperate with the QoS manager module 104 to define and monitor expected network quality levels. In accordance with embodiments of the present invention, a client may be presented with actual network performance and expected quality levels for such quality parameters as availability, mean time to restore (MTTR), mean time between service outages (MTBSO), bandwidth utilization, delay, errors, and faults.

Following a QoS analysis, a service provider and/or the customer may wish to shape the traffic carried by the various VCs in a VPN to better utilize the network 22. In this regard, the traffic shaping viewer module 158 may be configured to cooperate with the traffic shaping advisor module 106 to allow a client, e.g., a service provider or customer, to specify or establish the traffic shaping characteristics for VCs supported by the access network elements 34a, 34b, 34c, 34d, 34e, and 34f. Based on a proposed traffic description, the traffic shaping advisor module 106 may generate a proposed traffic shaping configuration for the affected access network elements 34a, 34b, 34c, 34d, 34e, and 34f and may update the access network elements 34a, 34b, 34c, 34d, 34e, and 34f upon approval of the client through the traffic shaping viewer module 158.

The VPN topology viewer module 162 maybe configured to cooperate with the VPN topology manager 108 to provide a graphical representation of the service network. For example, a service provider or customer may view the segments of the network 22 that comprise a particular VPN. In accordance with embodiments of the present invention, performance information along with expected quality levels may be graphically associated with the network segments. For example, a segment between two network elements may represent one or more VCs. A color may be assigned to the segment based on how many of the VCs, if any, violate an availability threshold or other quality and/or performance parameter.

Although FIGS. 3-6 illustrate an exemplary software architecture that may facilitate managing the quality of service provided by a network, it will be understood that the present invention is not limited to such a configuration but is intended to encompass any configuration capable of carrying out the operations described herein. Computer program code for carrying out operations of the respective program modules may be written in an object-oriented programming language, such as Java, Smalltalk, or C++. Computer program code for carrying out operations of the present invention may also, however, be written in conventional procedural programming languages, such as the C programming language or compiled Basic (CBASIC). Furthermore, some modules or routines may be written in assembly language or even micro-code to enhance performance and/or memory usage.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

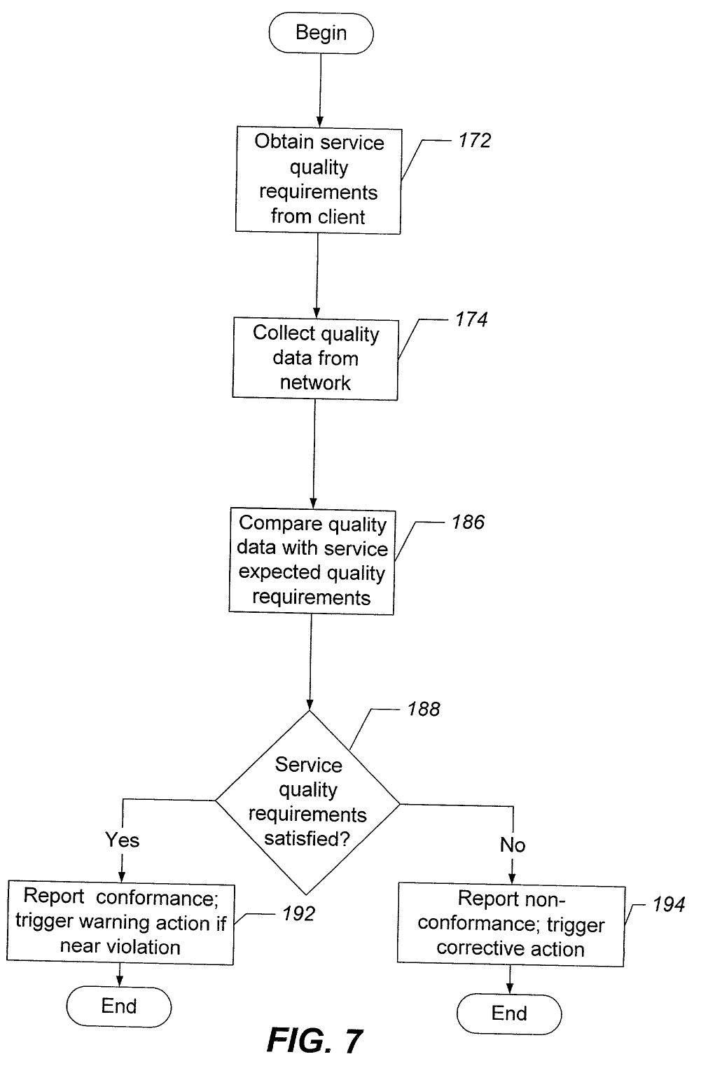

With reference to the flowcharts of FIGS. 7-20 and the architectural block diagrams of FIGS. 3-6, exemplary operations of methods, systems, and computer program products for managing the quality of service provided by a service provider, in accordance with embodiments of the present invention, will be described hereafter. Operations begin at block 172 where the service contract manager module 102 and/or the QoS manager module 104 receives network quality and/or performance requirements from a client, such as a service provider or customer, via the service contract viewer module 154 and/or QoS viewer module 156. Next, at block 174, the data collection module 112 may collect service quality data from the network 22 and/or other systems.

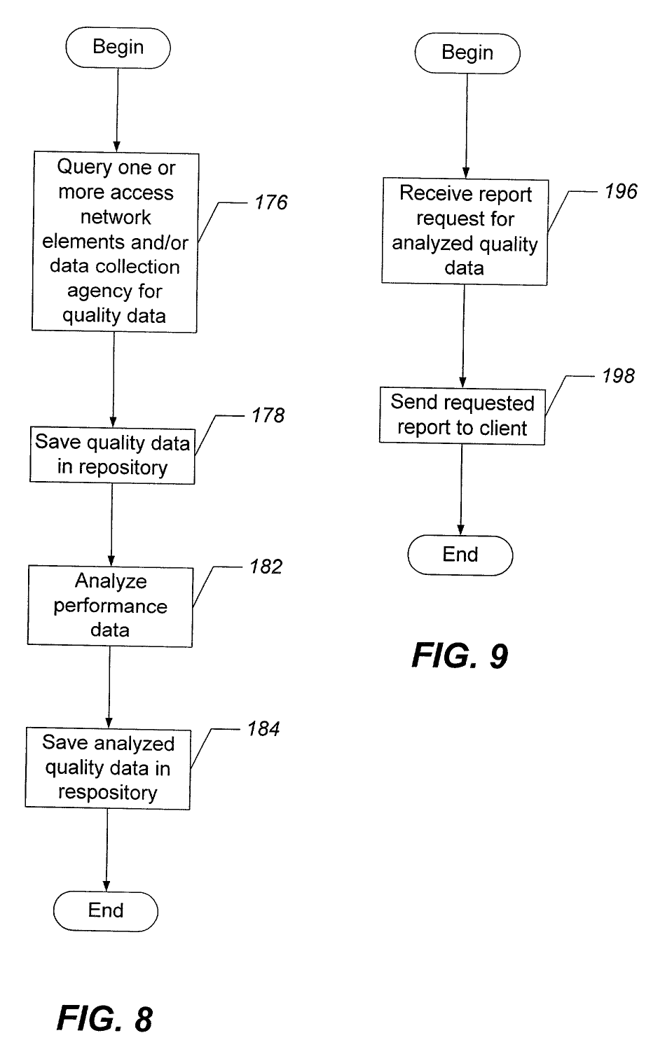

In accordance with particular embodiments of the present invention illustrated in FIG. 8, the data collection module 112 may query one or more access network elements 34a, 34b, 34c, 34d, 34e, and 34f to obtain the quality data at block 176. This query may be performed periodically according to a configured frequency, which may default to 15 minutes. Once the quality and/or performance data has been collected from the network 22, the data collection module 112 may cooperate with the repository module 132 to save the quality and/or performance data in a repository at block 178.

At block 182, the VPN topology manager module 108 may retrieve the saved quality data from a repository to analyze the quality data through application of one or more algorithmic techniques. The VPN topology manager module 108 may then cooperate with the repository module 132 to save the analyzed quality data in a repository at block 184.

Returning to FIG. 7, the service contract manager module 102 may compare the quality data and any analysis that may be performed thereon with the service quality requirements agreed on by the service provider and the client at block 186. If the quality requirements are satisfied at block 188, then one or more of the service contract manager module 102, the QoS manager module 104, and the VPN topology manager module 108 may respectively cooperate with the one or more of the service contract viewer module 154, the QoS viewer module 156 and the VPN topology viewer module 162 at block 192 to report that the service quality conforms with the client's requirements. If the quality data indicates that the service quality being provided is close to not satisfying the service quality requirements, then a warning action may be triggered. On the other hand, if the quality requirements are not satisfied at block 188, then non-conformance may be reported at block 194 and an action may be triggered based on the service quality requirements.

In accordance with particular embodiments of the present invention illustrated in FIG. 9, reports of service quality being in conformance or non-conformance with the service provider quality requirements may be instituted at block 196 by one or more of the service contract manager module 102, the QoS manager module 104, and the VPN topology manager module 108 receiving a report request for the analyzed quality data from a respective one or more of the service contract viewer module 154, the QoS viewer module 156, and the VPN topology viewer module 162. In response, the requested report may be sent from the service management system 24 to the client computer system at block 198.

Service Quality Analysis

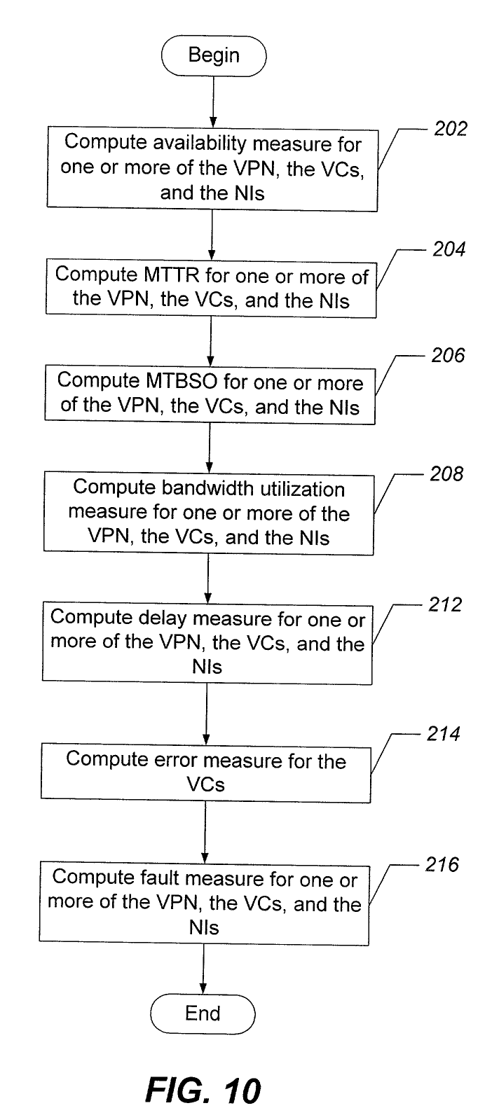

With reference to FIG. 10, quality data analysis techniques that may be used by the VPN topology manager module 108, in accordance with embodiments of the present invention, will be described hereafter. It will be understood that the formulas and equations described hereafter are for purposes of illustration. Additional equations/formulas may be used and results may be computed for statistics over time to get minimum, maximum, and average values. Moreover, the equations and formulas described herein may be changed based on quality and/or performance requirements. In general, one or more of the data analysis techniques set forth in FIG. 10 may be used to compute quality and/or performance measures for respective network 22 quality parameters. These performance and quality measures may be indicative of the quality of service provided by the service provider and the network 22. At block 202, the VPN topology manager module 108 may compute an availability measure for one or more of the VPN, the VCs and the NIs.

Connection availability may be determined based on the availability of either end point of the connection. In exemplary embodiments of the present invention, a time interval may be defined for computing the connection availability. During this time interval, the time in which either connection end point is out of service is computed. The end point outage time comprises those times in which the end point is accumulating errored seconds (ES), severe errored seconds (SES) (i.e., seconds during which at least 10 errors are incurred), and unavailable seconds (UAS) (e.g., seconds in which an end point is out of service for maintenance, diagnostics, etc.). Thus, for example, VC availability may be given by Equation 1 below:

$$VC Availability = \frac{Interval Time - VC Outage Time}{Interval Time} \qquad \text{EQ. 1}$$

NI availability may be computed in similar fashion to the VC availability. NI outage time is computed based on hard and soft failures. Hard failures correspond to those times in which the NI is out of service as a result of, for example, self-test failures and/or loss of signal. Soft failures correspond to the error performance in the physical layer and are represented, for example, by ES and SES. If either a soft or hard failure is incurred, NI outage time is accumulated. Thus, for example, the NI availability may be given by Equation 2 below:

$$NI Availability = \frac{Interval Time - NI Outage Time}{Interval Time} \qquad \text{EQ. 2}$$

Finally, VPN availability may be computed based on the availability of the VCs of which it is comprised. In accordance with embodiments of the present invention, VPN availability may be presented in alternative ways. For example, VPN availability may be given by the total outage time for all VCs comprising the VPN during a given service time. VPN availability may alternatively be given by a graph of the percentage of available VCs comprising the VPN over time. Finally, VPN availability may be given by the minimum availability of any VC of which the VPN is comprised, which is set forth in Equation 3 below and used as a default VPN availability algorithm in exemplary embodiments of the present invention.

VPN Availability=Min (Availability (VCs)) for VCs comprising the VPN EQ. 3

Returning to FIG. 10, at block 204, the VPN topology manager module 108 may, for example, compute a mean time to restore (MTTR) measure for one or more of the VPN, the VCs, and the NIs as set forth below in Equation 4:

$$MTTR = \frac{Total Unavailable Time - Total Excluded Time}{Number of instances an outage has been declared} \qquad \text{EQ. 4}$$

Likewise, at block 206, the VPN topology manager module 108 may compute a mean time between service outages for one or more of the VPN, the VCs, and the NIs as set forth below in Equation 5:

$$MTBSO = \frac{\begin{matrix}Tot . Available Time - Tot . Unavailable Time - \\ Tot . Excluded Time\end{matrix}}{\begin{matrix}Number of continuous intervals \\ that entity is available\end{matrix}} \qquad \text{EQ. 5}$$

The excluded time may correspond to time that an entity (i.e., a VPN, VC, or NI) is intentionally taken out of service for maintenance, diagnostics, natural disaster, or the like. The MTTR and MTBSO measures for a VPN may be based on the MTTR and MTBSO measures that are computed for the VCs that comprise the VPN.

At block 208, the VPN topology manager module 108 may compute a bandwidth utilization measure for one or more of the VPN, the VCs, and the NIs. VC utilization may be computed by computing a VC incoming utilization and a VC outgoing utilization. The VC incoming utilization may be computed by dividing the scheduled count of incoming cells during a particular time interval, which may be 15 minutes as a default, to the number of available cells during this same time interval. The number of available cells may be given by the product of the peak cell rate (PCR) or bandwidth allocated and the time interval. The VC outgoing utilization may be computed by dividing the scheduled count of outgoing cells during the particular time interval by the number of available cells during this time interval. The number of available cells may be given by the product of the PCR or allocated bandwidth and the time interval or the product of the sustainable cell rate (SCR) or allocated bandwidth and the time interval. The overall VC utilization may then be computed by averaging the VC incoming utilization with the VC outgoing utilization.

In accordance with embodiments of the present invention, the NI utilization may be computed by using the same methodology used to compute the VC utilization. Similar to VPN availability, VPN utilization may be based on the utilization of the VCs of which the VPN is comprised. Thus, for example, VPN utilization may be given by Equation 6 set forth below:

$$VPN Utilization = \frac{Sum of VC Utilization}{Number of VCs} \qquad \text{EQ. 6}$$

At block 212, the VPN topology manager module 108 may compute a delay measure for one or more of the VPN, the VCs, and the NIs. The delay computations may include both cell delay variation (CDV) and round trip transfer delay (RTTD). CDV is typically used in jitter sensitive traffic, constant bit rate (CBR) service applications. RTTD is typically used to measure the quality and/or performance of delay sensitive applications. CDV and RTTD values are generally measured by the access network elements 34a, 34b, 34c, 34d, 34e, and 34f and, therefore, may be obtained therefrom for VCs. Accordingly, the VPN topology manager module 108 may compute the CDV and RTTD for the VPN. Like VPN availability and bandwidth utilization, the CDV and RTTD measures for the VPN may be based on the CDB and RTTD measures for the VCs comprising the VPN as set forth below, for example, in Equations 7 and 8:

$$\begin{matrix}Ave . VPN CDV = \frac{Sum of CDV for VCs}{Number of VCs} & \text{EQ. 7} \\ Ave . VPN RTTD = \frac{Sum of CDV for VCs}{Number of VCs} & \text{EQ. 8}\end{matrix}$$

At block 214, the VPN topology manager module 108 may determine an error measure for the connections in a VPN. In accordance with embodiments of the present invention, the error measure may include data for one or more of the following connection error parameters: the number of lost bytes or cells, the number of misinserted bytes or cells, the number of discarded bytes or cells, the number of errored bytes or cells, and the number of bytes or cells that violate network quality and/or performance requirements set by the client. The quality and/or performance requirements set by the client may relate to overflow in the buffering mechanisms related to the traffic contract. For example, a generalized cell rate algorithm (GCRA) requirement may be defined, which defines a conformance standard with respect to a traffic contract for a connection, and/or a usage parameter control (UPC) requirement, which corresponds to actions taken by the network 22 to monitor and control traffic thereon.

The foregoing error measures may be obtained from the access network elements 34a, 34b, 34c, 34d, 34e, and 34f; therefore, the VPN topology manager module 108 need not compute these measures. The VPN topology manager module 108 may, for example, compute the following three error ratios for the VCs based on the error measures obtained from the access network elements 34a, 34b, 34c, 34d, 34e, and 34f: cell loss ratio (CLR), cell error ratio (CER), and severe error cell block ratio (SECBR).

At block 216, the VPN topology manager module 108 may determine a fault measure for one or more of the VPN, the VCs, and the NIs. In accordance with embodiments of the present invention, the fault measure may include data for one or more of the following parameters: a number of errored seconds (ES), a number of severely errored seconds (SES), and a number of unavailable seconds (UAS). The foregoing fault measures may be obtained from the access network elements 34a, 34b, 34c, 34d, 34e, and 34f; therefore, the VPN topology manager module 108 need not compute these measures.

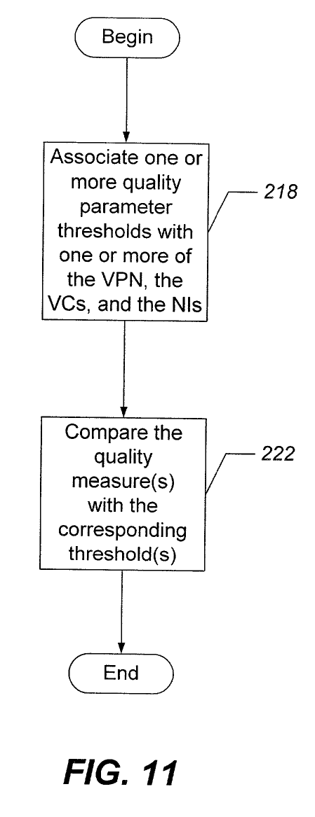

In accordance with embodiments of the present invention illustrated in FIG. 11, one or more thresholds corresponding to particular quality and/or performance parameters may be associated with any or all of the VPN, the VCs, and the NIs at block 218. For example, with regard to the bandwidth utilization performance parameter, over utilization thresholds and under utilization thresholds may be respectively associated with the VPN, the VCs and/or the NIs. In addition, with regard to the availability performance parameter, availability thresholds may be respectively associated with the VPN, the VCs and/or the NIs. At block 222, the quality and/or performance measures that have been computed for the VPN, the VCs, and/or the NIs may be compared with any corresponding availability thresholds that are associated therewith to determine whether the network 22 is in conformance with service quality requirements. These quality thresholds may be provided by a client and/or a service provider via the service contract viewer module 154 and/or the QoS viewer module 156.

Because the quality and/or performance thresholds may typically correspond to quality and/or performance requirements set by one or both of the service provider and the customer, a comparison of the particular quality and/or performance measure with any threshold that may be associated therewith may also be included in a service report that is sent to a client as discussed hereinabove with respect to FIG. 9.

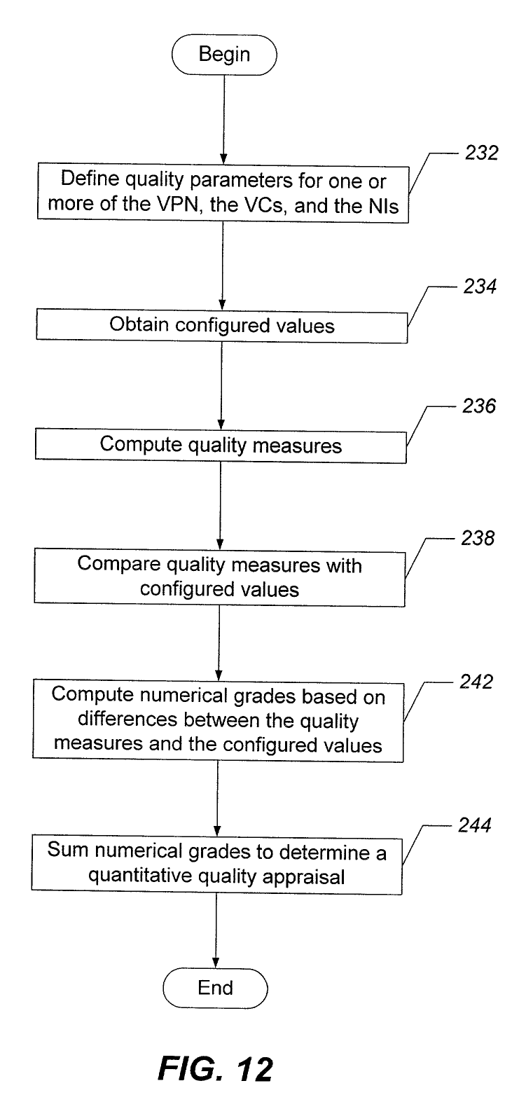

In accordance with further embodiments of the present invention illustrated in FIG. 12, the VPN topology manager module 108 may use the quality measures corresponding to the various quality parameters discussed hereinabove with respect to FIG. 10 to obtain a quantitative quality and/or performance appraisal of one or more of the VPN, the VCs, and the NIs. This quantitative quality and/or performance appraisal may be used by a client, e.g., a service provider and/or a customer, as an indicator of the health of the service and/or network 22. Referring now to FIG. 12, operations begin at block 232 where the quality and/or performance parameters used to evaluate the health of the service and/or network with respect to a VPN, the VCs, and/or the NIs are defined. At block 234, a configured value is obtained for each quality and/or performance parameter, which represents a quality and/or performance requirement or expected standard of quality and/or performance. The quality and/or performance parameters and configured values may be obtained from a client via the service contract viewer module 154 and/or the QoS viewer module 156.

Next, at block 236 the VPN topology manager module 108 computes the service quality measures corresponding to the quality parameters defined at block 232 as discussed hereinabove with respect to FIG. 10. The VPN topology manager module 108 may then compare the computed quality measures with the corresponding configured values at block 238 to determine differences therebetween. A grade may be assigned for each respective quality parameter based on the difference between the computed quality measure (i.e., the actual performance of the network 22 for that parameter) and the configured value corresponding to that respective parameter at block 242. Finally, at block 244, the grades for the respective quality parameters may be summed to compute a quantitative quality and/or performance appraisal of the VPN, VCs, and/or the NIs.

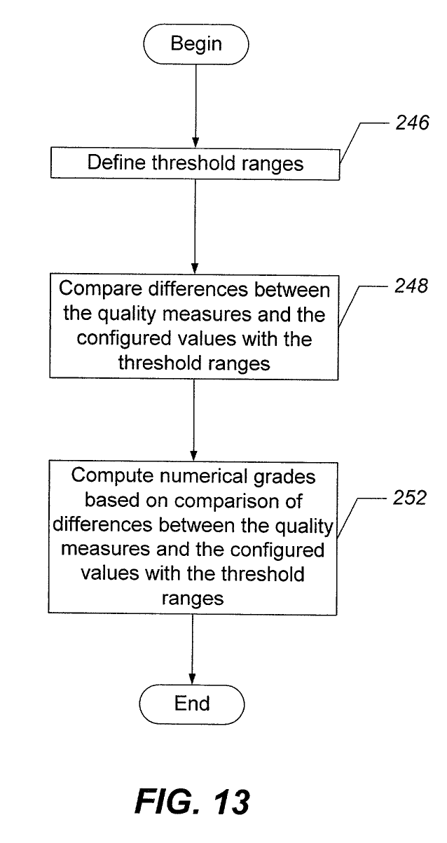

In accordance with particular embodiments of the present invention illustrated in FIG. 13, threshold ranges may be defined at block 246, which define how much each respective quality measure may deviate from its corresponding configured value and still be considered acceptable. Thus, at block 248, the VPN topology manager module 108 may compare the computed quality measures with the corresponding configured values and the threshold ranges to determine differences therebetween. The numerical grades for the respective quality parameters may then be computed at block 252 based on the differences between the quality measures and the configured values with the plurality of threshold ranges. In accordance with further embodiments of the present invention, the VPN topology manager module 108 may use TABLE 1 set forth hereafter to compute grades for each of the quality parameters.

TABLE 1

| | |
|---|---|
| Quality Measure is between the | Assign grade of 1 |
| Configured Value and the Configured | |
| Value + (Upper Threshold − Configured | |
| Value)/2 | |
| Quality Measure is between the | Assign grade of −1 |
| Configured Value and the Configured | |
| Value − (Configured Value − Lower | |
| Threshold)/2 | |
| Quality Measure is equal to or exceeds | Assign grade of 2 |
| the Configured Value + (Upper − Threshold | |
| Configured Value)/2 | |
| Quality Measure is equal to or less than | Assign grade of −2 |
| the Configured Value − (Configured | |
| Value − Lower Threshold)/2 | |
| Quality Measure equals Configured | Assign grade of 0 |
| Value | |

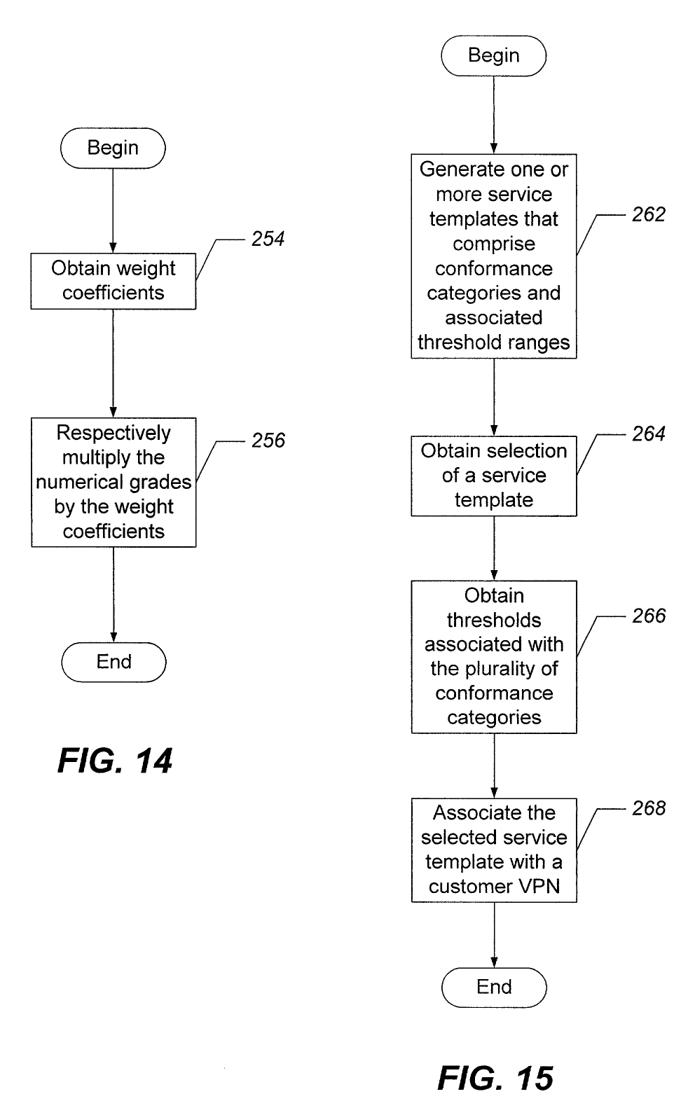

It may be desirable to weight one quality parameter more heavily than another quality parameter when computing the quantitative appraisal of service and/or network 22 health. Accordingly, as illustrated in FIG. 14, weight coefficients may be obtained based on default values for the quality parameters or from a client via the service contract viewer module 154 and/or the QoS viewer module 156, at block 254. These coefficients may then be used by the VPN topology manager module 108 to multiply the respective numerical grades, which were computed at block 242 of FIG. 12 or block 252 of FIG. 13, at block 256 before the numerical grades are summed to determine an overall quality appraisal.

Finally, based on the sum total of the numerical grades as optionally weighted by the weight coefficients, a qualitative appraisal may be assigned to the VPN, VCs, and/or NIs. For example, if the final sum as computed at block 244 of FIG. 12 is less than −2, then the quality or health of the VPN, VCs, and/or NIs may be considered “poor.” If the final sum is between −2 and 2, then the quality or health of the VPN, VCs, and/or NIs may be considered “acceptable.” Lastly, if the final sum is greater than 2, then the VPN, VCs, and/or NIs may be considered “good.” Note that both the quantitative appraisal and the qualitative appraisal may be determined for the VCs and the NIs individually. The quantitative appraisal for a VPN may then be computed based on the quantitative quality appraisal of the VCs comprising the VPN, which in turn may be used to determine a qualitative quality appraisal for the VPN.

As discussed hereinabove, the quantitative appraisal may be called a “health index” as it may provide an indication of the health of a service and/or the network, which may be communicated to a client, such as a service provider or customer. The QoS manager module 104 may associate exemplary quality parameters with various service classes, such as, for example, ATM service classes. For example, the CBR and RT-VBR classes may use availability, CLR, CDV, and RTTD as quality parameters; the NRT-VBR class may use availability, CLR, and RTTD as quality parameters; and the UBR class may use availability and CLR as quality parameters. Note that even though the CBR and RT-VBR classes may use the same quality parameters, they may nevertheless weight these parameters differently. For example, the CBR class may assign availability a weight of 4, CLR a weight of 1, CDV a weight of 3, and RTTD a weight of 2. Conversely, the RT-VBR class may assign availability a weight of 4, CLR a weight of 2, CDB a weight of 3, and RTTD a weight of 2.

Service Contract Generation and Conformance Management

As discussed hereinabove, the service management system 24 may include a service contract manager module 102 that may cooperate with a service contract viewer module 154 executing on a client computer system to generate and maintain a SLA. In general, a SLA is a contract between, for example, a service provider and its customer(s) that specifies the various quality parameters and quality levels (i.e., performance thresholds) that the service provider agrees to provide. Although an SLA is typically based on a service entity, such as a VPN, the various quality parameters may be VPN based, VC based, and/or NI based. Embodiments of the present invention may be used to manage a SLA between a service provider and a customer of the service provider by first generating an SLA template or package, similar to a service package, and then associating the SLA template with the particular customer and service to create a SLA contract.

Referring now to FIG. 15, operations of exemplary embodiments of the present invention for managing a service agreement between a service provider and a customer begin at block 262 where the service contract manager module 102 and QoS manager module 104 generate one or more service templates that each comprise conformance categories for a service agreement. The conformance categories may correspond to various quality parameters, such as an availability category, a delay category, an error category, an MTTR category, and/or a MTBSO category. Moreover, in particular embodiments of the present invention, the service agreement may not be unilateral but may also be bilateral and used to bind a customer to a certain traffic contract. Therefore, the conformance categories may include customer traffic parameters such as PCR, SCR, CDVT, GCRA, and/or UPC disagreement for ATM. A threshold range is then associated with each conformance category, which specifies a range of valid thresholds that may be defined for the particular conformance category.

Next, at block 264, a service provider and/or customer through the service contract viewer module 154 provides input to the service contract manager to select a particular service template that will be used to generate a SLA contract. The service provider and/or customer may then, at block 266, enter thresholds via the QoS viewer module 156 for each of the conformance categories in the selected service template that are within the range of valid thresholds specified at block 262. These thresholds will be received by the QoS manager module 104 and used by the VPN topology manager module 108 to determine whether the service and/or the network 22 quality and performance complies with the SLA contract. To generate the SLA contract, the service contract manager module 102 associates the selected service template and thresholds with a specific customer VPN at block 268.

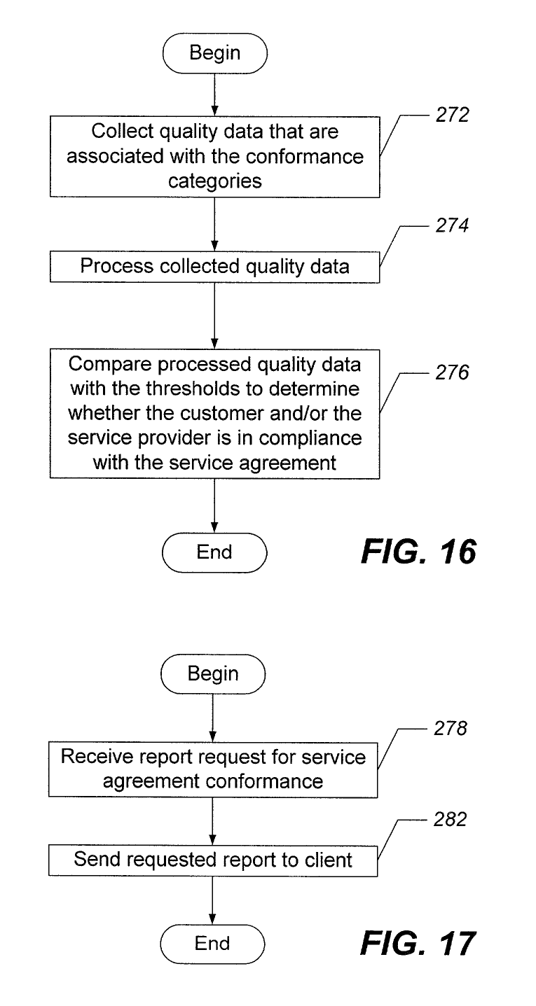

Advantageously, the present invention may be used to generate a SLA contract and also to monitor the quality and/or performance of a service and/or the network 22 to ensure that a service provider and/or a customer is in compliance with the SLA contract terms. FIG. 16 illustrates embodiments of the present invention that may be used for determining compliance with an SLA contract. At block 272 the data collection module 112 may collect quality and/or performance data from the access network elements 34a, 34b, 34c, 34d, 34e, and 34f that are associated with the SLA conformance categories. Once the quality and/or performance data have been collected, the VPN topology manager module 108 may process the data at block 274 by, for example, computing quality measures as discussed hereinabove with respect to FIG. 10. The processed quality data may then be compared with the thresholds for each of the conformance categories by the service contract manager module 102 at block 276 to determine whether the service provider is delivering a quality of service that meets the thresholds defined in the SLA contract and/or whether the customer is adhering to its prescribed traffic contract.

As shown in further embodiments of the present invention illustrated in FIG. 17, a client, e.g., a service provider or a customer, may monitor the conformance status of an SLA contract by sending a request for an SLA contract conformance report to the service contract manager module 102 via the service contract viewer module 154 at block 278. In response, the service contract manager module 102 may send a report to the client at block 282 that contains the thresholds for the various conformance categories and a comparison of the processed quality data (e.g., quality measures) from the network 22 with each conformance category threshold.

Traffic Shaping

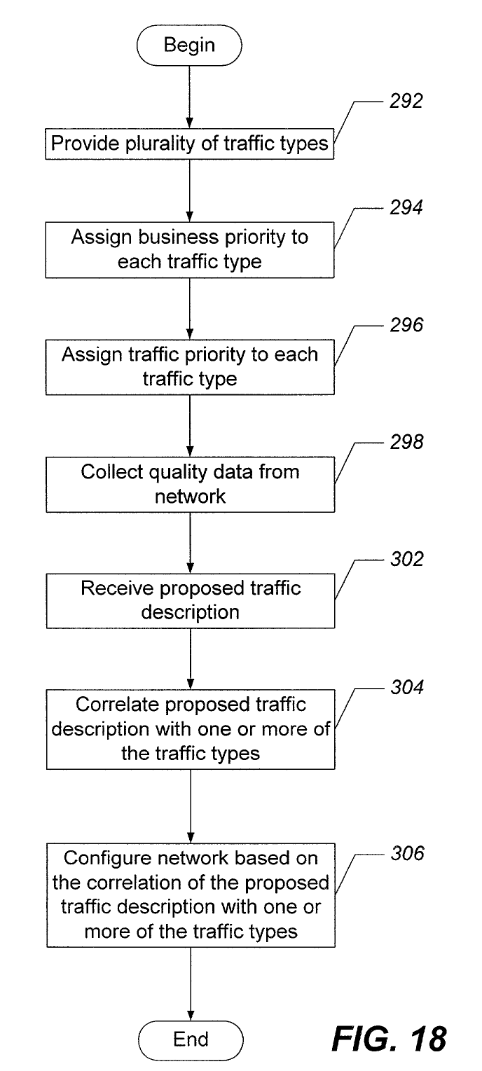

Once a client, such as a service provider or customer, has performed a QoS analysis on an information network, such as the network 22 as discussed hereinabove, they may wish to shape the traffic carried by the various VCs in a VPN to better utilize the network 22. Advantageously, the service management system 24 may be used to generate a configuration for carrying a proposed traffic stream and then to update the network elements comprising the network 22. For example, embodiments for shaping traffic on a network, in accordance with the present invention, are illustrated in FIG. 18. At block 292, the traffic shaping advisor module 106 provides a plurality of traffic types that may be carried by the network 22. Each traffic type may have associated therewith a business priority and a traffic priority as represented by blocks 294 and 296, respectively. The associations between traffic types, business priorities, and traffic priorities may be maintained in a data structure as represented, for example, by TABLE 2 set forth below:

TABLE 2

| Traffic Type | Traffic Priority | Business Priority |
|---|---|---|
| Graphics File | Medium | None |
| Hypertext Markup | High | None |
| Language File | | |
| Real-time stream Audio | Low | None |
| Real-time stream Video | Low | None |
| Business File Transfer | Low | High |
| Telnet | High | None |

At block 298, the data collection module 112 may collect quality data from the access network elements 34a, 34b, 34c, 34d, 34e, and 34f This quality data may include availability data, bandwidth utilization data, and data indicative of network element buffer sizes and cell distribution. The client may provide a proposed traffic description to the traffic shaping advisor module 106 at block 302 via the traffic shaping viewer module 158. The traffic shaping advisor module 106 may then, at block 304, correlate the proposed traffic description with one or more of the traffic types provided at block 292. Based on this correlation, the traffic shaping advisor module 106 may use the traffic priority and the business priority associated with the correlated traffic types along with the quality data (i.e., knowledge of the network element buffer capacity, throughput, error rate, fault rate, etc.) to configure various network elements in the network 22 through the adaptation facilities module 92 to carry the traffic proposed by the client at block 306.

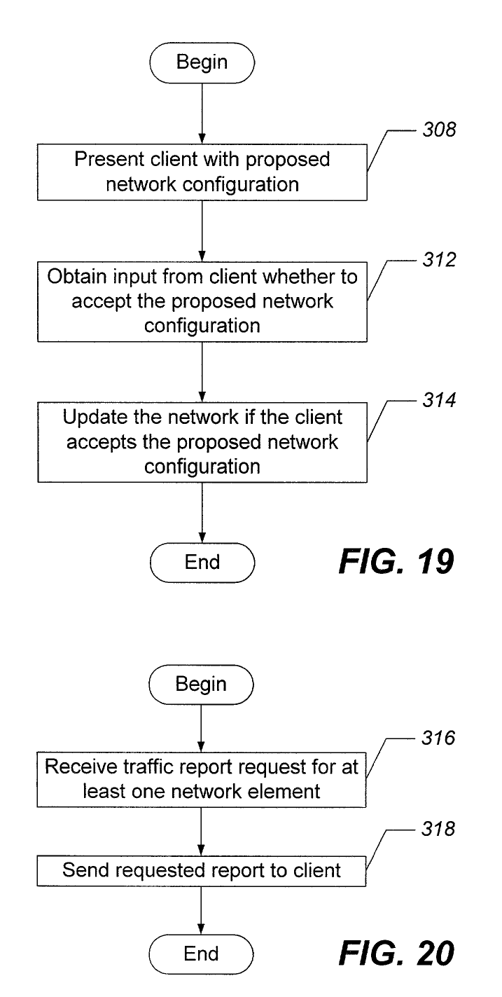

In particular embodiments of the present invention illustrated in FIG. 19, the traffic shaping advisor module 106 may present the client with a proposed network configuration for carrying the proposed traffic description via the traffic shaping viewer module 158 at block 308. The client may then provide input to the traffic shaping advisor module 106 via the traffic shaping viewer module 158 at block 312 to indicate whether to accept the proposed network configuration or whether to reject the proposed network configuration. If the client accepts the proposed network configuration, then the network elements may be configured accordingly at block 314. In this manner, automated traffic shaping may be provided while allowing the client to review any final network configuration before implementation.

Finally, in further embodiments of the present invention illustrated in FIG. 20, a client, e.g., a service provider or a customer, may monitor the traffic carried on the network elements comprising one or more VCs in the network 22 by sending a traffic report request to the traffic shaping advisor module 106 via the traffic shaping viewer module 158 at block 316. In response, the traffic shaping advisor module 106 may send a report to the client at block 318 that contains an indication of the traffic that is allocated to one or more network elements comprising a VC.

The flowcharts of FIGS. 7-20 show the architecture, functionality, and operation of exemplary implementations of the software and data used to manage the quality of service provided by a network in accordance with the present invention. In this regard, each block may represent a module, segment, or portion of code, which comprises one or more executable instructions for implementing the specified logical function(s). It should also be noted that in some alternative implementations, the functions noted in the blocks may occur out of the order noted in FIGS. 7-20. For example, two blocks shown in succession in FIGS. 7-20 may be executed substantially concurrently or the blocks may sometimes be executed in the reverse order, depending upon the functionality involved.

From the foregoing it can readily be seen that, in accordance with the present invention, a service management system may be used to retrieve quality of service information from a network, analyze that information, and compare the analyzed information against defined service or conformance thresholds to determine whether the network is performing up to expectations. If the network is deficient in some way, then a client, such as a service provider or customer, may be notified to allow the client to take corrective action by, for example, reshaping the traffic on the network.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

We claim:

1. A method of managing a service, comprising the steps of:
obtaining service quality requirements from a client;
collecting quality data from a network; and
comparing the collected quality data with the service quality requirements to determine if the service quality requirements are satisfied.

2. A method as recited in claim 1, wherein the network comprises a plurality of network elements and the step of collecting quality data from the network comprises the steps of:
querying at least one access network element for the quality data, the at least one access network element comprising those network elements of the plurality of network elements that are configured at an edge of the network and provide access to the network;
saving the quality data in a repository;
analyzing the quality data; and
saving the analyzed quality data in the repository.

3. A method as recited in claim 2, where the step of querying the at least one access network element for the quality data comprises the step of:
querying at least one of the at least one access network element and a data collection agency for the quality data.

4. A method as recited in claim 2, wherein the network comprises an asynchronous transfer mode (ATM) virtual private network (VPN), the VPN comprising at least one virtual channel (VC), wherein the at least one access network element comprises at least one network interface (NI), and wherein the step of analyzing the quality data comprises the step of:
computing an availability measure for at least one of the VPN, the at least one VC, and the at least one NI.

5. A method as recited in claim 4, wherein the availability measure of the VPN is based on the availability measure of the at least one VC.

6. A method as recited in claim 4, wherein the step of analyzing the quality data further comprises the steps of:
computing a mean time to restore (MTTR) measure for the at least one of the VPN, the at least one VC, and the at least one NI; and
computing a mean time between service outages (MTBSO) measure for the at least one of the VPN, the at least one VC, and the at least one NI.

7. A method as recited in claim 6, wherein the MTTR measure of the VPN and the MTBSO measure of the VPN are based on the MTTR measure of the at least one VC and the MTBSO measure of the at least one VC, respectively.

8. A method as recited in claim 6, further comprising the steps of:
receiving a service availability report request from the client for the at least one of the VPN, the at least one VC, and the at least one NI; and
sending the requested service availability report to the client for the at least one of the VPN, the at least one VC, and the at least one NI, the requested service availability report comprising at least one of the availability measure, the MTTR measure, and the MTSBO measure for the at least one of the VPN, the at least one VC, and the at least one NI.

9. A method as recited in claim 6, further comprising the steps of:
associating an availability threshold with at least one of the VPN, the at least one VC, and the at least one NI; and
comparing the availability measure for the at least one of the VPN, the at least one VC, and the at least one NI with the respectively associated availability threshold.

10. A method as recited in claim 9, further comprising the steps of:
receiving a service availability report request from the client for the at least one of the VPN, the at least one VC, and the at least one NI; and
sending the requested service availability report to the client for the at least one of the VPN, the at least one VC, and the at least one NI, the requested service availability report comprising at least one of the availability measure, the MTTR measure, and the MTSBO measure for the at least one of the VPN, the at least one VC, and the at least one NI and a comparison of the availability measure for the at least one of the VPN, the at least one VC, and the at least one NI with the availability threshold that is associated with the at least one of the VPN, the at least one VC, and the at least one NI.

11. A method as recited in claim 2, wherein the network comprises an asynchronous transfer mode (ATM) virtual private network (VPN), the VPN comprising at least one virtual channel (VC), wherein the at least one access network element comprises at least one network interface (NI), and wherein the step of analyzing the quality data comprises the step of:
computing a bandwidth utilization measure for at least one of the VPN, the at least one VC, and the at least one NI.

12. A method as recited in claim 11, wherein the bandwidth utilization measure of the VPN is based on the bandwidth utilization measure of the at least one VC.

13. A method as recited in claim 11, further comprising the steps of:
receiving a bandwidth utilization report request from the client for the at least one of the VPN, the at least one VC, and the at least one NI; and
sending the requested bandwidth utilization report to the client for the at least one of the VPN, the at least one VC, and the at least one NI, the requested bandwidth utilization report comprising the bandwidth utilization measure for the at least one of the VPN, the at least one VC, and the at least one NI.

14. A method as recited in claim 1, further comprising the steps of:
associating an over utilization threshold and an under utilization threshold with the at least one of the VPN, the at least one VC, and the at least one NI; and
comparing the bandwidth utilization measure for the at least one of the VPN, the at least one VC, and the at least one NI with the respectively associated over utilization threshold and under utilization threshold.

15. A method as recited in claim 14, further comprising the steps of:
receiving a bandwidth utilization report request from the client for the at least one of the VPN, the at least one VC, and the at least one NI; and
sending the requested bandwidth utilization report to the client for the at least one of the VPN, the at least one VC, and the at least one NI, the requested bandwidth utilization report comprising the bandwidth utilization measure for the at least one of the VPN, the at least one VC, and the at least one NI and a comparison of the bandwidth utilization measure for the at least one of the VPN, the at least one VC, and the at least one NI with the over utilization threshold and under utilization threshold that are associated with the at least one of the VPN, the at least one VC, and the at least one NI.

16. A method as recited in claim 2, wherein the network comprises an asynchronous transfer mode (ATM) virtual private network (VPN), the VPN comprising at least one virtual channel (VC), wherein the at least one access network element comprises at least one network interface (NI), and wherein the step of analyzing the quality data comprises the step of:
computing a delay measure for at least one of the VPN, the at least one VC, and the at least one NI.

17. A method as recited in claim 16, wherein the delay measure of the VPN is based on the delay measure of the at least one VC.

18. A method as recited in claim 16, wherein the step of computing the delay measure for the at least one of the VPN, the at least one VC, and the at least one NI comprises the steps of:
computing a cell delay variation (CDV) measure for the at least one of the VPN, the at least one VC, and the at least one NI; and
computing a round trip transfer delay (RTTD) measure for the at least one of the VPN, the at least one VC, and the at least one NI.

19. A method as recited in claim 18, further comprising the steps of:
receiving a delay report request from the client for the at least one of the VPN, the at least one VC, and the at least one NI; and
sending the requested delay report to the client for the at least one of the VPN, the at least one VC, and the at least one NI, the requested delay report comprising at least one of the CDV measure and the RTTD measure for the at least one of the VPN, the at least one VC, and the at least one NI.

20. A method as recited in claim 2, wherein the network comprises an asynchronous transfer mode (ATM) virtual private network (VPN), the VPN comprising at least one virtual channel (VC), wherein the at least one access network element comprises at least one network interface (NI), and wherein the step of analyzing the quality data comprises the step of:
computing an error measure for the at least one VC.

21. A method as recited in claim 20, wherein the step of computing the error measure for the at least one VC comprises the steps of:
determining at least one of a number of lost cells, a number of misinserted cells, a number of discarded cells, a number of errored cells, and a number of cells that violate the service quality requirements from the client for the at least one VC; and
computing at least one of a cell loss ratio (CLR), a cell error ratio (CER), and a severely errored cell block ratio (SECBR) for the at least one VC.

22. A method as recited in claim 21, further comprising the steps of:
receiving an error report request from the client for the at least one VC; and
sending the requested error report to the client for the at least one VC, the requested error report comprising at least one of the number of lost cells, the number of misinserted cells, the number of discarded cells, the number of errored cells, the number of cells that violate the service quality requirements from the client, the CLR, the CER, and the SECBR for the at least one VC.

23. A method as recited in claim 2, wherein the network comprises an asynchronous transfer mode (ATM) virtual private network (VPN), the VPN comprising at least one virtual channel (VC), wherein the at least one access network element comprises at least one network interface (NI), and wherein the step of analyzing the quality data comprises the step of:
computing a fault measure for at least one of the VPN, the at least one VC, and the at least one NI.

24. A method as recited in claim 23, wherein the step of computing the fault measure for the at least one of the VPN, the at least one VC, and the at least one NI comprises the step of:
determining at least one of a number of errored seconds (ES), a number of severely errored seconds (SES), and a number of unavailable seconds (UAS) for the at least one of the VPN, the at least one VC, and the at least one NI.

25. A method as recited in claim 24, further comprising the steps of:
receiving a fault report request from the client for the at least one of the VPN, the at least one VC, and the at least one NI; and
sending the requested fault report to the client for the at least one of the VPN, the at least one VC, and the at least one NI, the requested fault report comprising at least one of the number of errored seconds (ES), the number of severely errored seconds (SES), and the number of unavailable seconds (UAS) for the at least one of the VPN, the at least one VC, and the at least one NI.

26. A method as recited in claim 2, wherein the network comprises an asynchronous transfer mode (ATM) virtual private network (VPN), the VPN comprising at least one virtual channel (VC), wherein the at least one access network element comprises at least one network interface (NI), and wherein the step of analyzing the quality data comprises the steps of:
defining a plurality of quality parameters for at least one of the VPN, the at least one VC, and the at least one NI;
obtaining a plurality of configured values, a respective one of which being associated with a respective one of the plurality of quality parameters;
computing a plurality of quality measures, a respective one of which being associated with the respective one of the plurality of quality parameters and the respective one of the plurality of configured values;
comparing the respective one of the plurality of quality measures with the respective one of the plurality of configured values to determine a plurality of differences therebetween;
computing a plurality of numerical grades, a respective one of which being based on a respective one of the plurality of differences; and
summing the plurality of numerical grades to determine a quantitative quality appraisal of the at least one of the VPN, the at least one VC, and the at least one NI.

27. A method as recited in claim 26, further comprising the step of:
defining a plurality of threshold ranges, a respective one of which being associated with the respective one of the plurality of quality parameters and the respective one of the plurality of configured values; and
comparing the respective one of the plurality of differences with the respective one of the plurality of threshold ranges.

28. A method as recited in claim 27, wherein the step of computing the plurality of numerical grades, the respective one of which being based on the respective one of the plurality of differences comprises the step of:
computing the plurality of numerical grades, the respective one of which being based on the comparison of the respective one of the plurality of differences with the respective one of the plurality of threshold ranges.

29. A method as recited in claim 26, further comprising the steps of:
obtaining a plurality of weight coefficients, a respective one of which being associated with the respective one of the plurality of quality parameters; and
multiplying the respective one of the plurality of numerical grades by the respective one of the plurality of weight coefficients prior to the step of summing the plurality of numerical grades to determine the quantitative quality appraisal of the at least one of the VPN, the at least one VC, and the at least one NI.

30. A method as recited in claim 26, wherein the plurality of weight coefficients are obtained from the client.

31. A method as recited in claim 26, further comprising the step of:
determining a qualitative quality appraisal of the at least one of the VPN, the at least one VC, and the at least one NI based on the quantitative quality appraisal of the at least one of the VPN, the at least one VC, and the at least one NI.

32. A method as recited in claim 26, wherein the quantitative quality appraisal of the VPN is based on the quantitative quality appraisal of the at least one VC.

33. A method as recited in claim 26, wherein the plurality of configured values are obtained from the client.

34. A method as recited in claim 26, wherein the plurality of quality parameters are associated with an ATM quality of service class selected from the group of service classes consisting of a constant bit rate (CBR) class, a real time variable bit rate (RT-VBR) class, a non-real time variable bit rate (NRT-VBR) class, an unspecified bit rate (UBR) class, and an available bit rate (ABR) class.

35. A method of managing a service agreement between a service provider on a network and a customer of the service provider, comprising the steps of:
generating at least one service template, a respective one of the at least one service template comprising:
a plurality of conformance categories; and
a plurality of threshold ranges, a respective one of which being associated with a respective one of the plurality of conformance categories;
obtaining input from one of the service provider and the customer to select one of the at least one service template;
obtaining a plurality of thresholds, a respective one of which being associated with the respective one of the plurality of conformance categories and being within the respective one of the plurality of threshold ranges; and
associating the selected service template and the plurality of thresholds with a virtual private network (VPN) that is associated with the customer to generate the service agreement.

36. A method as recited in claim 35, further comprising the steps of:
collecting quality data that are associated with the plurality of conformance categories from the network;
processing the collected quality data; and
comparing the processed quality data with the plurality of thresholds to determine whether the service provider is in compliance with the service agreement.

37. A method as recited in claim 36, wherein the plurality of conformance categories comprise a plurality of customer traffic parameters, the method further comprising the steps of:
collecting quality data that are associated with the plurality of customer traffic parameters;
processing the collected quality data that are associated with the plurality of customer traffic parameters; and
comparing the collected quality data that are associated with the plurality of customer traffic parameters with the plurality of thresholds to determine whether the customer is in compliance with the service agreement.

38. A method as recited in claim 37, wherein the network comprises an asynchronous transfer mode (ATM) network, the ATM network comprising a plurality of network elements including at least one access network element that is configured at an edge of the ATM network and provides access to the ATM network, the at least one access network element comprising at least one network interface (NI), wherein the VPN comprises at least one virtual channel (VC), and wherein the step of processing the collected quality data comprises the step of:
processing the collected quality data for at least one of the VPN, the at least one VC, and the at least one NI.

39. A method as recited in claim 38, further comprising the steps of:
receiving a service agreement conformance report request from at least one of the service provider and the customer for the at least one of the VPN, the at least one VC, and the at least one NI; and
sending the requested service agreement conformance report to the at least one of the service provider and the customer for the at least one of the VPN, the at least one VC, and the at least one NI, the service agreement conformance report comprising the comparison of the processed quality data and the respective threshold for at least one of the plurality of conformance categories for the at least one of the VPN, the at least one VC, and the at least one NI.

40. A method as recited in claim 37, wherein the plurality of conformance categories further comprises at least one of an availability category, a delay category, an error category, a mean time to restore (MTTR) category, and a mean time between service outages (MTBSO) category, and wherein the plurality of customer traffic parameters comprises at least one of peak cell rate (PCR), sustainable cell rate (SCR), cell delay variation tolerance (CDVT), generalized cell rate algorithm (GCRA), and usage parameter control (UPC) disagreement.

41. A method of configuring a network to carry traffic, comprising the steps of:
providing a plurality of traffic types;
assigning a respective business priority to a respective one of the plurality of traffic types;
assigning a respective traffic priority to the respective one of the plurality of traffic types based on the respective one of the plurality of traffic types and the respective business priority assigned thereto;
collecting quality data from the network;
receiving a proposed traffic description;
correlating the proposed traffic description with at least one of the plurality of traffic types; and
configuring the network based on the correlation of the proposed traffic description with the at least one of the plurality of traffic types, the business and traffic priorities that are assigned to the at least one of the plurality of traffic types, and the quality data collected from the network.

42. A method as recited in claim 41, wherein the step of providing the plurality of traffic types comprises the step of:
obtaining client input to provide the plurality of traffic types; and wherein the step of assigning the respective business priority to the respective one of the plurality of traffic types comprises the step of:
obtaining client input to assign the respective business priority to the respective one of the plurality of traffic types.

43. A method as recited in claim 41, wherein the step of configuring the network based on the correlation of the proposed traffic description with the at least one of the plurality of traffic types, the business and traffic priorities that are assigned to the at least one of the plurality of traffic types, and the quality data collected from the network comprises the steps of:
presenting a client with a proposed network configuration based on the correlation of the proposed traffic description with the at least one of the plurality of traffic types, the business and traffic priorities that are assigned to the at least one of the plurality of traffic types, and the quality data collected from the network;
obtaining input from the client whether to accept the proposed network configuration; and
updating the network based on the proposed network configuration if the client accepts the proposed network configuration.

44. A method as recited in claim 41, wherein the step of collecting quality data from the network comprises the step of:
collecting at least one of availability data and bandwidth utilization data from the network.

45. A method as recited in claim 41, wherein the network comprises a plurality of network elements including at least one access network element that is configured at an edge of the network and provides access to the network, the method further comprising the steps of:
receiving a traffic report request from a client for one of the at least one access network element; and
sending the requested traffic report request to the client for the one of the at least one access network element, the requested traffic report request comprising an indication of traffic that is allocated to the one of the at least one access network element.

46. A system for managing a service, comprising:
means for obtaining service quality requirements from a client;
means for collecting quality data from a network; and
means for comparing the collected quality data with the service quality requirements to determine if the service quality requirements are satisfied.

47. A system as recited in claim 46, wherein the network comprises a plurality of network elements and the means for collecting quality data from the network comprises:
means for querying at least one access network element for the quality data, the at least one access network element comprising those network elements of the plurality of network elements that are configured at an edge of the network and provide access to the network;
means for saving the quality data in a repository;
means for analyzing the quality data; and
means for saving the analyzed quality data in the repository.

48. A system as recited in claim 47, where the means for querying the at least one access network element for the quality data comprises:
means for querying at least one of the at least one access network element and a data collection agency for the quality data.

49. A system as recited in claim 47, wherein the network comprises an asynchronous transfer mode (ATM) virtual private network (VPN), the VPN comprising at least one virtual channel (VC), wherein the at least one access network element comprises at least one network interface (NI), and wherein the means for analyzing the quality data comprises:
means for computing an availability measure for at least one of the VPN, the at least one VC, and the at least one NI.

50. A system as recited in claim 49, wherein the availability measure of the VPN is based on the availability measure of the at least one VC.

51. A system as recited in claim 49, wherein the means for analyzing the quality data further comprises:
means for computing a mean time to restore (MTTR) measure for the at least one of the VPN, the at least one VC, and the at least one NI; and means for computing a mean time between service outages (MTBSO) measure for the at least one of the VPN, the at least one VC, and the at least one NI.

52. A system as recited in claim 51, wherein the MTTR measure of the VPN and the MTBSO measure of the VPN are based on the MTTR measure of the at least one VC and the MTBSO measure of the at least one VC, respectively.

53. A system as recited in claim 51, further comprising:
means for receiving a service availability report request from the client for the at least one of the VPN, the at least one VC, and the at least one NI; and
means for sending the requested service availability report to the client for the at least one of the VPN, the at least one VC, and the at least one NI, the requested service availability report comprising at least one of the availability measure, the MTTR measure, and the MTSBO measure for the at least one of the VPN, the at least one VC, and the at least one NI.

54. A system as recited in claim 51, further comprising:
means for associating an availability threshold with at least one of the VPN, the at least one VC, and the at least one NI; and
means for comparing the availability measure for the at least one of the VPN, the at least one VC, and the at least one NI with the respectively associated availability threshold.

55. A system as recited in claim 54, further comprising:
means for receiving a service availability report request from the client for the at least one of the VPN, the at least one VC, and the at least one NI; and
means for sending the requested service availability report to the client for the at least one of the VPN, the at least one VC, and the at least one NI, the requested service availability report comprising at least one of the availability measure, the MTTR measure, and the MTSBO measure for the at least one of the VPN, the at least one VC, and the at least one NI and a comparison of the availability measure for the at least one of the VPN, the at least one VC, and the at least one NI with the availability threshold that is associated with the at least one of the VPN, the at least one VC, and the at least one NI.

56. A system as recited in claim 47, wherein the network comprises an asynchronous transfer mode (ATM) virtual private network (VPN), the VPN comprising at least one virtual channel (VC), wherein the at least one access network element comprises at least one network interface (NI), and wherein the means for analyzing the quality data comprises:
means for computing a bandwidth utilization measure for at least one of the VPN, the at least one VC, and the at least one NI.

57. A system as recited in claim 56, wherein the bandwidth utilization measure of the VPN is based on the bandwidth utilization measure of the at least one VC.

58. A system as recited in claim 56, further comprising:
means for receiving a bandwidth utilization report request from the client for the at least one of the VPN, the at least one VC, and the at least one NI; and
means for sending the requested bandwidth utilization report to the client for the at least one of the VPN, the at least one VC, and the at least one NI, the requested bandwidth utilization report comprising the bandwidth utilization measure for the at least one of the VPN, the at least one VC, and the at least one NI.

59. A system as recited in claim 56, further comprising:
means for associating an over utilization threshold and an under utilization threshold with the at least one of the VPN, the at least one VC, and the at least one NI; and
means for comparing the bandwidth utilization measure for the at least one of the VPN, the at least one VC, and the at least one NI with the respectively associated over utilization threshold and under utilization threshold.

60. A system as recited in claim 59, further comprising:
means for receiving a bandwidth utilization report request from the client for the at least one of the VPN, the at least one VC, and the at least one NI; and
means for sending the requested bandwidth utilization report to the client for the at least one of the VPN, the at least one VC, and the at least one NI, the requested bandwidth utilization report comprising the bandwidth utilization measure for the at least one of the VPN, the at least one VC, and the at least one NI and a comparison of the bandwidth utilization measure for the at least one of the VPN, the at least one VC, and the at least one NI with the over utilization threshold and under utilization threshold that are associated with the at least one of the VPN, the at least one VC, and the at least one NI.

61. A system as recited in claim 47, wherein the network comprises an asynchronous transfer mode (ATM) virtual private network (VPN), the VPN comprising at least one virtual channel (VC), wherein the at least one access network element comprises at least one network interface (NI), and wherein the means for analyzing the quality data comprises:
means for computing a delay measure for at least one of the VPN, the at least one VC, and the at least one NI.

62. A system as recited in claim 61, wherein the delay measure of the VPN is based on the delay measure of the at least one VC.

63. A system as recited in claim 61, wherein the means for computing the delay measure for the at least one of the VPN, the at least one VC, and the at least one NI comprises:
means for computing a cell delay variation (CDV) measure for the at least one of the VPN, the at least one VC, and the at least one NI; and
means for computing a round trip transfer delay (RTTD) measure for the at least one of the VPN, the at least one VC, and the at least one NI.

64. A system as recited in claim 63, further comprising:
means for receiving a delay report request from the client for the at least one of the VPN, the at least one VC, and the at least one NI; and
means for sending the requested delay report to the client for the at least one of the VPN, the at least one VC, and the at least one NI, the requested delay report comprising at least one of the CDV measure and the RTTD measure for the at least one of the VPN, the at least one VC, and the at least one NI.

65. A system as recited in claim 47, wherein the network comprises an asynchronous transfer mode (ATM) virtual private network (VPN), the VPN comprising at least one virtual channel (VC), wherein the at least one access network element comprises at least one network interface (NI), and wherein the means for analyzing the quality data comprises:
means for computing an error measure for the at least one VC.

66. A system as recited in claim 65, wherein the means for computing the error measure for the at least one VC comprises:
means for determining at least one of a number of lost cells, a number of misinserted cells, a number of discarded cells, a number of errored cells, and a number of cells that violate the service quality requirements from the client for the at least one VC; and
means for computing at least one of a cell loss ratio (CLR), a cell error ratio (CER), and a severely errored cell block ratio (SECBR) for the at least one VC.

67. A system as recited in claim 66, further comprising:
means for receiving an error report request from the client for the at least one VC; and
means for sending the requested error report to the client for the at least one VC, the requested error report comprising at least one of the number of lost cells, the number of misinserted cells, the number of discarded cells, the number of errored cells, the number of cells that violate the service quality requirements from the client, the CLR, the CER, and the SECBR for the at least one VC.

68. A system as recited in claim 47, wherein the network comprises an asynchronous transfer mode (ATM) virtual private network (VPN), the VPN comprising at least one virtual channel (VC), wherein the at least one access network element comprises at least one network interface (NI), and wherein the means for analyzing the quality data comprises:
means for computing a fault measure for at least one of the VPN, the at least one VC, and the at least one NI.

69. A system as recited in claim 68, wherein the means for computing the fault measure for the at least one of the VPN, the at least one VC, and the at least one NI comprises:
means for determining at least one of a number of errored seconds (ES), a number of severely errored seconds (SES), and a number of unavailable seconds (UAS) for the at least one of the VPN, the at least one VC, and the at least one NI.

70. A system as recited in claim 69, further comprising:
means for receiving a fault report request from the client for the at least one of the VPN, the at least one VC, and the at least one NI; and
means for sending the requested fault report to the client for the at least one of the VPN, the at least one VC, and the at least one NI, the requested fault report comprising at least one of the number of errored seconds (ES), the number of severely errored seconds (SES), and the number of unavailable seconds (UAS) for the at least one of the VPN, the at least one VC, and the at least one NI.

71. A system as recited in claim 47, wherein the network comprises an asynchronous transfer mode (ATM) virtual private network (VPN), the VPN comprising at least one virtual channel (VC), wherein the at least one access network element comprises at least one network interface (NI), and wherein the means for analyzing the quality data comprises:
means for defining a plurality of quality parameters for at least one of the VPN, the at least one VC, and the at least one NI;
means for obtaining a plurality of configured values, a respective one of which being associated with a respective one of the plurality of quality parameters;
means for computing a plurality of quality measures, a respective one of which being associated with the respective one of the plurality of quality parameters and the respective one of the plurality of configured values;
means for comparing the respective one of the plurality of quality measures with the respective one of the plurality of configured values to determine a plurality of differences therebetween;
means for computing a plurality of numerical grades, a respective one of which being based on a respective one of the plurality of differences; and
means for summing the plurality of numerical grades to determine a quantitative quality appraisal of the at least one of the VPN, the at least one VC, and the at least one NI.

72. A system as recited in claim 71, further comprising:
means for defining a plurality of threshold ranges, a respective one of which being associated with the respective one of the plurality of quality parameters and the respective one of the plurality of configured values; and
means for comparing the respective one of the plurality of differences with the respective one of the plurality of threshold ranges.

73. A system as recited in claim 72, wherein the means for computing the plurality of numerical grades, the respective one of which being based on the respective one of the plurality of differences comprises:
means for computing the plurality of numerical grades, the respective one of which being based on the comparison of the respective one of the plurality of differences with the respective one of the plurality of threshold ranges.

74. A system as recited in claim 71, further comprising:
means for obtaining a plurality of weight coefficients, a respective one of which being associated with the respective one of the plurality of quality parameters; and
means for multiplying the respective one of the plurality of numerical grades by the respective one of the plurality of weight coefficients, the means for summing the plurality of numerical grades to determine the quantitative quality appraisal of the at least one of the VPN, the at least one VC, and the at least one NI being responsive to the means for multiplying the respective one of the plurality of numerical grades by the respective one of the plurality of weight coefficients.

75. A system as recited in claim 71, wherein the plurality of weight coefficients are obtained from the client.

76. A system as recited in claim 71, further comprising:
means for determining a qualitative quality appraisal of the at least one of the VPN, the at least one VC, and the at least one NI based on the quantitative quality appraisal of the at least one of the VPN, the at least one VC, and the at least one NI.

77. A system as recited in claim 71, wherein the quantitative quality appraisal of the VPN is based on the quantitative quality appraisal of the at least one VC.

78. A system as recited in claim 71, wherein the plurality of configured values are obtained from the client.

79. A system as recited in claim 71, wherein the plurality of quality parameters are associated with an ATM quality of service class selected from the group of service classes consisting of a constant bit rate (CBR) class, a real time variable bit rate (RT-VBR) class, a non-real time variable bit rate (NRT-VBR) class, an unspecified bit rate (UBR) class, and an available bit rate (ABR) class.

80. A system for managing a service agreement between a service provider on a network and a customer of the service provider, comprising:
means for generating at least one service template, a respective one of the at least one service template comprising:
a plurality of conformance categories; and
a plurality of threshold ranges, a respective one of which being associated with a respective one of the plurality of conformance categories;
means for obtaining input from one of the service provider and the customer to select one of the at least one service template;
means for obtaining a plurality of thresholds, a respective one of which being associated with the respective one of the plurality of conformance categories and being within the respective one of the plurality of threshold ranges; and
means for associating the selected service template and the plurality of thresholds with a virtual private network (VPN) that is associated with the customer to generate the service agreement.

81. A system as recited in claim 80, further comprising:
means for collecting quality data that are associated with the plurality of conformance categories from the network;
means for processing the collected quality data; and
means for comparing the processed quality data with the plurality of thresholds to determine whether the service provider is in compliance with the service agreement.

82. A system as recited in claim 81, wherein the plurality of conformance categories comprise a plurality of customer traffic parameters, the system further comprising:
means for collecting quality data that are associated with the plurality of customer traffic parameters;
means for processing the collected quality data that are associated with the plurality of customer traffic parameters; and
means for comparing the collected quality data that are associated with the plurality of customer traffic parameters with the plurality of thresholds to determine whether the customer is in compliance with the service agreement.

83. A system as recited in claim 82, wherein the network comprises an asynchronous transfer mode (ATM) network, the ATM network comprising a plurality of network elements including at least one access network element that is configured at an edge of the ATM network and provides access to the ATM network, the at least one access network element comprising at least one network interface (NI), wherein the VPN comprises at least one virtual channel (VC), and wherein the means for processing the collected quality data comprises:
means for processing the collected quality data for at least one of the VPN, the at least one VC, and the at least one NI.

84. A system as recited in claim 83, further comprising:
means for receiving a service agreement conformance report request from at least one of the service provider and the customer for the at least one of the VPN, the at least one VC, and the at least one NI; and
means for sending the requested service agreement conformance report to the at least one of the service provider and the customer for the at least one of the VPN, the at least one VC, and the at least one NI, the service agreement conformance report comprising the comparison of the processed quality data and the respective threshold for at least one of the plurality of conformance categories for the at least one of the VPN, the at least one VC, and the at least one NI.

85. A system as recited in claim 82, wherein the plurality of conformance categories further comprises at least one of an availability category, a delay category, an error category, a mean time to restore (MTTR) category, and a mean time between service outages (MTBSO) category, and wherein the plurality of customer traffic parameters comprises at least one of peak cell rate (PCR), sustainable cell rate (SCR), cell delay variation tolerance (CDVT), generalized cell rate algorithm (GCRA), and usage parameter control (UPC) disagreement.

86. A system for configuring a network to carry traffic, comprising:
means for providing a plurality of traffic types;
means for assigning a respective business priority to a respective one of the plurality of traffic types;
means for assigning a respective traffic priority to the respective one of the plurality of traffic types based on the respective one of the plurality of traffic types and the respective business priority assigned thereto;
means for collecting quality data from the network;
means for receiving a proposed traffic description;
means for correlating the proposed traffic description with at least one of the plurality of traffic types; and
means for configuring the network based on the correlation of the proposed traffic description with the at least one of the plurality of traffic types, the business and traffic priorities that are assigned to the at least one of the plurality of traffic types, and the quality data collected from the network.

87. A system as recited in claim 86, wherein the means for providing the plurality of traffic types comprises:
means for obtaining client input to provide the plurality of traffic types; and
wherein the means for assigning the respective business priority to the respective one of the plurality of traffic types comprises:
means for obtaining client input to assign the respective business priority to the respective one of the plurality of traffic types.

88. A system as recited in claim 86, wherein the means for configuring the network based on the correlation of the proposed traffic description with the at least one of the plurality of traffic types, the business and traffic priorities that are assigned to the at least one of the plurality of traffic types, and the quality data collected from the network comprises:
means for presenting a client with a proposed network configuration based on the correlation of the proposed traffic description with the at least one of the plurality of traffic types, the business and traffic priorities that are assigned to the at least one of the plurality of traffic types, and the quality data collected from the network;
means for obtaining input from the client whether to accept the proposed network configuration; and
means for updating the network based on the proposed network configuration if the client accepts the proposed network configuration.

89. A system as recited in claim 86, wherein the means for collecting quality data from the network comprises:
means for collecting at least one of availability data and bandwidth utilization data from the network.

90. A system as recited in claim 86, wherein the network comprises a plurality of network elements including at least one access network element that is configured at an edge of the network and provides access to the network, the system further comprising:
means for receiving a traffic report request from a client for one of the at least one access network element; and
means for sending the requested traffic report request to the client for the one of the at least one access network element, the requested traffic report request comprising an indication of traffic that is allocated to the one of the at least one access network element.

91. A computer program product for managing a service, comprising:
a computer readable storage medium having computer readable program code embodied therein, the computer readable program code comprising:
computer readable program code for obtaining service quality requirements from a client;
computer readable program code for collecting quality data from a network; and
computer readable program code for comparing the collected quality data with the service quality requirements to determine if the service quality requirements are satisfied.

92. A computer program product as recited in claim 91, wherein the network comprises a plurality of network elements and the computer readable program code for collecting quality data from the network comprises:
computer readable program code for querying at least one access network element for the quality data, the at least one access network element comprising those network elements of the plurality of network elements that are configured at an edge of the network and provide access to the network;
computer readable program code for saving the quality data in a repository;
computer readable program code for analyzing the quality data; and
computer readable program code for saving the analyzed quality data in the repository.

93. A computer program product as recited in claim 92, where the computer readable program code for querying the at least one access network element for the quality data comprises:
computer readable program code for querying at least one of the at least one access network element and a data collection agency for the quality data.

94. A computer program product as recited in claim 92, wherein the network comprises an asynchronous transfer mode (ATM) virtual private network (VPN), the VPN comprising at least one virtual channel (VC), wherein the at least one access network element comprises at least one network interface (NI), and wherein the computer readable program code for analyzing the quality data comprises:
computer readable program code for computing an availability measure for at least one of the VPN, the at least one VC, and the at least one NI.

95. A computer program product as recited in claim 94, wherein the availability measure of the VPN is based on the availability measure of the at least one VC.

96. A computer program product as recited in claim 94, wherein the computer readable program code for analyzing the quality data further comprises:
computer readable program code for computing a mean time to restore (MTTR) measure for the at least one of the VPN, the at least one VC, and the at least one NI; and
computer readable program code for computing a mean time between service outages (MTBSO) measure for the at least one of the VPN, the at least one VC, and the at least one NI.

97. A computer program product as recited in claim 96, wherein the MTTR measure of the VPN and the MTBSO measure of the VPN are based on the MTTR measure of the at least one VC and the MTBSO measure of the at least one VC, respectively.

98. A computer program product as recited in claim 96, further comprising:
computer readable program code for receiving a service availability report request from the client for the at least one of the VPN, the at least one VC, and the at least one NI; and
computer readable program code for sending the requested service availability report to the client for the at least one of the VPN, the at least one VC, and the at least one NI, the requested service availability report comprising at least one of the availability measure, the MTTR measure, and the MTSBO measure for the at least one of the VPN, the at least one VC, and the at least one NI.

99. A computer program product as recited in claim 96, further comprising:
computer readable program code for associating an availability threshold with at least one of the VPN, the at least one VC, and the at least one NI; and
computer readable program code for comparing the availability measure for the at least one of the VPN, the at least one VC, and the at least one NI with the respectively associated availability threshold.

100. A computer program product as recited in claim 99, further comprising:
computer readable program code for receiving a service availability report request from the client for the at least one of the VPN, the at least one VC, and the at least one NI; and
computer readable program code for sending the requested service availability report to the client for the at least one of the VPN, the at least one VC, and the at least one NI, the requested service availability report comprising at least one of the availability measure, the MTTR measure, and the MTSBO measure for the at least one of the VPN, the at least one VC, and the at least one NI and a comparison of the availability measure for the at least one of the VPN, the at least one VC, and the at least one NI with the availability threshold that is associated with the at least one of the VPN, the at least one VC, and the at least one NI.

101. A computer program product as recited in claim 92, wherein the network comprises an asynchronous transfer mode (ATM) virtual private network (VPN), the VPN comprising at least one virtual channel (VC), wherein the at least one access network element comprises at least one network interface (NI), and wherein the computer readable program code for analyzing the quality data comprises:
computer readable program code for computing a bandwidth utilization measure for at least one of the VPN, the at least one VC, and the at least one NI.

102. A computer program product as recited in claim 101, wherein the bandwidth utilization measure of the VPN is based on the bandwidth utilization measure of the at least one VC.

103. A computer program product as recited in claim 101, further comprising:
computer readable program code for receiving a bandwidth utilization report request from the client for the at least one of the VPN, the at least one VC, and the at least one NI; and
computer readable program code for sending the requested bandwidth utilization report to the client for the at least one of the VPN, the at least one VC, and the at least one NI, the requested bandwidth utilization report comprising the bandwidth utilization measure for the at least one of the VPN, the at least one VC, and the at least one NI.

104. A computer program product as recited in claim 101, further comprising:
computer readable program code for associating an over utilization threshold and an under utilization threshold with the at least one of the VPN, the at least one VC, and the at least one NI; and
computer readable program code for comparing the bandwidth utilization measure for the at least one of the VPN, the at least one VC, and the at least one NI with the respectively associated over utilization threshold and under utilization threshold.

105. A computer program product as recited in claim 104, further comprising:
computer readable program code for receiving a bandwidth utilization report request from the client for the at least one of the VPN, the at least one VC, and the at least one NI; and
computer readable program code for sending the requested bandwidth utilization report to the client for the at least one of the VPN, the at least one VC, and the at least one NI, the requested bandwidth utilization report comprising the bandwidth utilization measure for the at least one of the VPN, the at least one VC, and the at least one NI and a comparison of the bandwidth utilization measure for the at least one of the VPN, the at least one VC, and the at least one NI with the over utilization threshold and under utilization threshold that are associated with the at least one of the VPN, the at least one VC, and the at least one NI.

106. A computer program product as recited in claim 92, wherein the network comprises an asynchronous transfer mode (ATM) virtual private network (VPN), the VPN comprising at least one virtual channel (VC), wherein the at least one access network element comprises at least one network interface (NI), and wherein the computer readable program code for analyzing the quality data comprises:
computer readable program code for computing a delay measure for at least one of the VPN, the at least one VC, and the at least one NI.

107. A computer program product as recited in claim 106, wherein the delay measure of the VPN is based on the delay measure of the at least one VC.

108. A computer program product as recited in claim 106, wherein the computer readable program code for computing the delay measure for the at least one of the VPN, the at least one VC, and the at least one NI comprises:
computer readable program code for computing a cell delay variation (CDV) measure for the at least one of the VPN, the at least one VC, and the at least one NI; and
computer readable program code for computing a round trip transfer delay (RTTD) measure for the at least one of the VPN, the at least one VC, and the at least one NI.

109. A computer program product as recited in claim 108, further comprising:
computer readable program code for receiving a delay report request from the client for the at least one of the VPN, the at least one VC, and the at least one NI; and
computer readable program code for sending the requested delay report to the client for the at least one of the VPN, the at least one VC, and the at least one NI, the requested delay report comprising at least one of the CDV measure and the RTTD measure for the at least one of the VPN, the at least one VC, and the at least one NI.

110. A computer program product as recited in claim 92, wherein the network comprises an asynchronous transfer mode (ATM) virtual private network (VPN), the VPN comprising at least one virtual channel (VC), wherein the at least one access network element comprises at least one network interface (NI), and wherein the computer readable program code for analyzing the quality data comprises:
computer readable program code for computing an error measure for the at least one VC.

111. A computer program product as recited in claim 110, wherein the computer readable program code for computing the error measure for the at least one VC comprises:
computer readable program code for determining at least one of a number of lost cells, a number of misinserted cells, a number of discarded cells, a number of errored cells, and a number of cells that violate the service quality requirements from the client for the at least one VC; and
computer readable program code for computing at least one of a cell loss ratio (CLR), a cell error ratio (CER), and a severely errored cell block ratio (SECBR) for the at least one VC.

112. A computer program product as recited in claim 111, further comprising:
computer readable program code for receiving an error report request from the client for the at least one VC; and
computer readable program code for sending the requested error report to the client for the at least one VC, the requested error report comprising at least one of the number of lost cells, the number of misinserted cells, the number of discarded cells, the number of errored cells, the number of cells that violate the service quality requirements from the client, the CLR, the CER, and the SECBR for the at least one VC.

113. A computer program product as recited in claim 92, wherein the network comprises an asynchronous transfer mode (ATM) virtual private network (VPN), the VPN comprising at least one virtual channel (VC), wherein the at least one access network element comprises at least one network interface (NI), and wherein the computer readable program code for analyzing the quality data comprises:
computer readable program code for computing a fault measure for at least one of the VPN, the at least one VC, and the at least one NI.

114. A computer program product as recited in claim 113, wherein the computer readable program code for computing the fault measure for the at least one of the VPN, the at least one VC, and the at least one NI comprises:
computer readable program code for determining at least one of a number of errored seconds (ES), a number of severely errored seconds (SES), and a number of unavailable seconds (UAS) for the at least one of the VPN, the at least one VC, and the at least one NI.

115. A computer program product as recited in claim 114, further comprising:
computer readable program code for receiving a fault report request from the client for the at least one of the VPN, the at least one VC, and the at least one NI; and
computer readable program code for sending the requested fault report to the client for the at least one of the VPN, the at least one VC, and the at least one NI, the requested fault report comprising at least one of the number of errored seconds (ES), the number of severely errored seconds (SES), and the number of unavailable seconds (UAS) for the at least one of the VPN, the at least one VC, and the at least one NI.

116. A computer program product as recited in claim 92, wherein the network comprises an asynchronous transfer mode (ATM) virtual private network (VPN), the VPN comprising at least one virtual channel (VC), wherein the at least one access network element comprises at least one network interface (NI), and wherein the computer readable program code for analyzing the quality data comprises:
computer readable program code for defining a plurality of quality parameters for at least one of the VPN, the at least one VC, and the at least one NI;
computer readable program code for obtaining a plurality of configured values, a respective one of which being associated with a respective one of the plurality of quality parameters;
computer readable program code for computing a plurality of quality measures, a respective one of which being associated with the respective one of the plurality of quality parameters and the respective one of the plurality of configured values;
computer readable program code for comparing the respective one of the plurality of quality measures with the respective one of the plurality of configured values to determine a plurality of differences therebetween;
computer readable program code for computing a plurality of numerical grades, a respective one of which being based on a respective one of the plurality of differences; and
computer readable program code for summing the plurality of numerical grades to determine a quantitative quality appraisal of the at least one of the VPN, the at least one VC, and the at least one NI.

117. A computer program product as recited in claim 116, further comprising:
computer readable program code for defining a plurality of threshold ranges, a respective one of which being associated with the respective one of the plurality of quality parameters and the respective one of the plurality of configured values; and
computer readable program code for comparing the respective one of the plurality of differences with the respective one of the plurality of threshold ranges.

118. A computer program product as recited in claim 117, wherein the computer readable program code for computing the plurality of numerical grades, the respective one of which being based on the respective one of the plurality of differences comprises:
computer readable program code for computing the plurality of numerical grades, the respective one of which being based on the comparison of the respective one of the plurality of differences with the respective one of the plurality of threshold ranges.

119. A computer program product as recited in claim 116, further comprising:
computer readable program code for obtaining a plurality of weight coefficients, a respective one of which being associated with the respective one of the plurality of quality parameters; and
computer readable program code for multiplying the respective one of the plurality of numerical grades by the respective one of the plurality of weight coefficients, the computer readable program code for summing the plurality of numerical grades to determine the quantitative quality appraisal of the at least one of the VPN, the at least one VC, and the at least one NI being responsive to the computer readable program code for multiplying the respective one of the plurality of numerical grades by the respective one of the plurality of weight coefficients.

120. A computer program product as recited in claim 116, wherein the plurality of weight coefficients are obtained from the client.

121. A computer program product as recited in claim 116, further comprising:
computer readable program code for determining a qualitative quality appraisal of the at least one of the VPN, the at least one VC, and the at least one NI based on the quantitative quality appraisal of the at least one of the VPN, the at least one VC, and the at least one NI.

122. A computer program product as recited in claim 116, wherein the quantitative quality appraisal of the VPN is based on the quantitative quality appraisal of the at least one VC.

123. A computer program product as recited in claim 116, wherein the plurality of configured values are obtained from the client.

124. A computer program product as recited in claim 116, wherein the plurality of quality parameters are associated with an ATM quality of service class selected from the group of service classes consisting of a constant bit rate (CBR) class, a real time variable bit rate (RT-VBR) class, a non-real time variable bit rate (NRT-VBR) class, an unspecified bit rate (UBR) class, and an available bit rate (ABR) class.

125. A computer program product for managing a service agreement between a service provider on a network and a customer of the service provider, comprising:
a computer readable storage medium having computer readable program code embodied therein, the computer readable program code comprising:
computer readable program code for generating at least one service template, a respective one of the at least one service template comprising:
a plurality of conformance categories; and
a plurality of threshold ranges, a respective one of which being associated with a respective one of the plurality of conformance categories;
computer readable program code for obtaining input from one of the service provider and the customer to select one of the at least one service template;
computer readable program code for obtaining a plurality of thresholds, a respective one of which being associated with the respective one of the plurality of conformance categories and being within the respective one of the plurality of threshold ranges; and
computer readable program code for associating the selected service template and the plurality of thresholds with a virtual private network (VPN) that is associated with the customer to generate the service agreement.

126. A computer program product as recited in claim 125, further comprising:
computer readable program code for collecting quality data that are associated with the plurality of conformance categories from the network;
computer readable program code for processing the collected quality data; and
computer readable program code for comparing the processed quality data with the plurality of thresholds to determine whether the service provider is in compliance with the service agreement.

127. A computer program product as recited in claim 126, wherein the plurality of conformance categories comprise a plurality of customer traffic parameters, the computer program product further comprising:
computer readable program code for collecting quality data that are associated with the plurality of customer traffic parameters;
computer readable program code for processing the collected quality data that are associated with the plurality of customer traffic parameters; and
computer readable program code for comparing the collected quality data that are associated with the plurality of customer traffic parameters with the plurality of thresholds to determine whether the customer is in compliance with the service agreement.

128. A computer program product as recited in claim 127, wherein the network comprises an asynchronous transfer mode (ATM) network, the ATM network comprising a plurality of network elements including at least one access network element that is configured at an edge of the ATM network and provides access to the ATM network, the at least one access network element comprising at least one network interface (NI), wherein the VPN comprises at least one virtual channel (VC), and wherein the computer readable program code for processing the collected quality data comprises:
computer readable program code for processing the collected quality data for at least one of the VPN, the at least one VC, and the at least one NI.

129. A computer program product as recited in claim 128, further comprising:
computer readable program code for receiving a service agreement conformance report request from at least one of the service provider and the customer for the at least one of the VPN, the at least one VC, and the at least one NI; and
computer readable program code for sending the requested service agreement conformance report to the at least one of the service provider and the customer for the at least one of the VPN, the at least one VC, and the at least one NI, the service agreement conformance report comprising the comparison of the processed quality data and the respective threshold for at least one of the plurality of conformance categories for the at least one of the VPN, the at least one VC, and the at least one NI.

130. A computer program product as recited in claim 127, wherein the plurality of conformance categories further comprises at least one of an availability category, a delay category, an error category, a mean time to restore (MTTR) category, and a mean time between service outages (MTBSO) category, and wherein the plurality of customer traffic parameters comprises at least one of peak cell rate (PCR), sustainable cell rate (SCR), cell delay variation tolerance (CDVT), generalized cell rate algorithm (GCRA), and usage parameter control (UPC) disagreement.

131. A computer program product for configuring a network to carry traffic, comprising:
a computer readable storage medium having computer readable program code embodied therein, the computer readable program code comprising:
computer readable program code for providing a plurality of traffic types;
computer readable program code for assigning a respective business priority to a respective one of the plurality of traffic types;
computer readable program code for assigning a respective traffic priority to the respective one of the plurality of traffic types based on the respective one of the plurality of traffic types and the respective business priority assigned thereto;
computer readable program code for collecting quality data from the network;
computer readable program code for receiving a proposed traffic description;
computer readable program code for correlating the proposed traffic description with at least one of the plurality of traffic types; and
computer readable program code for configuring the network based on the correlation of the proposed traffic description with the at least one of the plurality of traffic types, the business and traffic priorities that are assigned to the at least one of the plurality of traffic types, and the quality data collected from the network.

132. A computer program product as recited in claim 131, wherein the computer readable program code for providing the plurality of traffic types comprises:
computer readable program code for obtaining client input to provide the plurality of traffic types; and wherein the computer readable program code for assigning the respective business priority to the respective one of the plurality of traffic types comprises:
computer readable program code for obtaining client input to assign the respective business priority to the respective one of the plurality of traffic types.

133. A computer program product as recited in claim 131, wherein the computer readable program code for configuring the network based on the correlation of the proposed traffic description with the at least one of the plurality of traffic types, the business and traffic priorities that are assigned to the at least one of the plurality of traffic types, and the quality data collected from the network comprises:
computer readable program code for presenting a client with a proposed network configuration based on the correlation of the proposed traffic description with the at least one of the plurality of traffic types, the business and traffic priorities that are assigned to the at least one of the plurality of traffic types, and the quality data collected from the network;
computer readable program code for obtaining input from the client whether to accept the proposed network configuration; and
computer readable program code for updating the network based on the proposed network configuration if the client accepts the proposed network configuration.

134. A computer program product as recited in claim 131, wherein the computer readable program code for collecting quality data from the network comprises:
computer readable program code for collecting at least one of availability data and bandwidth utilization data from the network.

135. A computer program product as recited in claim 131, wherein the network comprises a plurality of network elements including at least one access network element that is configured at an edge of the network and provides access to the network, the computer program product further comprising:
computer readable program code for receiving a traffic report request from a client for one of the at least one access network element; and
computer readable program code for sending the requested traffic report request to the client for the one of the at least one access network element, the requested traffic report request comprising an indication of traffic that is allocated to the one of the at least one access network element.
